(19) United States
(12) Patent Application Publication
(10) Pub. No.: US 2013/0165350 A1
(43) Pub. Date: Jun. 27, 2013

(54) SURFACE LINKERS FOR ARRAY SYNTHESIS

(71) Applicants: Robert Kuimelis, Palo Alto, CA (US); Glenn McGall, Palo Alto, CA (US); Dexter Pao, San Jose, CA (US); Zihui Chen, Mountain View, CA (US); Trevor Axelrod, Oak Park, IL (US)

(72) Inventors: Robert Kuimelis, Palo Alto, CA (US); Glenn McGall, Palo Alto, CA (US); Dexter Pao, San Jose, CA (US); Zihui Chen, Mountain View, CA (US); Trevor Axelrod, Oak Park, IL (US)

(73) Assignee: Affymetrix, Inc., Santa Clara, CA (US)

(21) Appl. No.: 13/335,677

(22) Filed: Dec. 22, 2011

(51) Int. Cl. C40B 50/18

(52) U.S. Cl. 506/32

(57) ABSTRACT

The present invention provide several methods of derivatizing a surface of a support with one or more linkers thus providing a suitable platform for synthesis of a polymer array, particular a nucleic acid array. Some methods derivatize a surface with a self-assembled monolayer (SAM) of a linker. The SAM confers advantages of hydrolytic stability, broad compatibility with synthesis and detection chemistries, and reduced emergence of latent functional groups during polymer array synthesis. Substrates can also be derivatized with multi-layers of SAMs providing greater hydrolytic stability. Substrates can also be derivatized by synthesizing a linker in situ on the substrate by atom transfer radical polymerization of functional and functional monomers. Appropriate selection of monomers reduces emergence of latent functional groups in subsequent array synthesis.

### BACKGROUND OF THE INVENTION

Silane linkers have been developed for derivatization of solid substrates, such as glass substrates. The linkers usually have a functional group distal from the silane group to provide an attachment point for further synthesis. Silane linkers have been used to prepare high density immobilized oligonucleotide and peptide arrays. N-(2-hydroxyethyl)-N,N-bis(trimethoxysilylpropyl)amine (HEBS) is a linker currently used in GeneChip® oligonucleotide arrays (see, e.g., US2006/0134672 and U.S. Pat. No. 6,994,964). This linker has a hetero atom and a relatively short branched structure. Combination of HEBS with a nonfunctional linker has been proposed as a means of reducing probe density and thereby enhancing hybridization signal of an array (US2009/0215652). Other silane linkers used in array synthesis include N-(3-(triethoxysilyl)-propyl)-4-hydroxybutyramide (Gelest Inc., Tullytown, Pa., see McGall et al., J. Am. Chem. Soc., 119: 5081-5090 (1997), and U.S. Pat. Nos. 5,959,098, 6,307,042, and 6,068,875, N,N-Bis(hydroxyethyl)amino-propyltriethoxysilane (HEBS) (McGall et al., Proc. Natl. Acad. Sci., 93: 13555-13560 (1996); Pease et al., Proc. Natl. Acad. Sci., 91: 5022-5026 (1994), U.S. Pat. No. 5,959,098, US 2008/0119371, and US 2005/0080284), acetoxypropyltriethoxy-silane (see WO97/39151) and 3-Glycidoxypropyltrimethoxysilane (see EP0368279).

Self-assembling monolayers have been used in several applications such as immobilizing pre-formed biopolymers (Luderet, Top. Curr. Chem. 260:37-56, 2005; US2010/0004137, US2005/0074898, US2010/0099203, US2011/0143966).

### BRIEF DESCRIPTION OF THE FIGURES

FIG. 1: N-(2-hydroxyethyl)-N,N-bis(trimethoxysilylpropyl)amine (hydroxyethyl bis-silane/“HEBS”) (left), and idealized depictions of ordered and complex polysiloxane thin film networks formed by deposition on a silica substrate (right). Reactive sites can emerge unintentionally due to rehydration or reorganization of the initially formed surface layer during subsequent processing used in the fabrication of arrays of oligonucleotides or other biomolecules. This can negatively impact the performance characteristics of such arrays.

FIGS. 2A, B, C: (A) Formation of functionalized self-assembled monolayers (SAMs) on silica substrates via co-deposition of mixtures of long-chain alkyl (LCA) trichlorosilanes, with and without terminal functional groups. The resulting areal density of reactive surface groups is controlled by varying the input ratio of the functional and nonfunctional LCA component silanes. (B): A 10-carbon “methyl terminated” silane contributes the inert, nonfunctional LCA, and an 11-carbon “acetoxy terminated” silane furnishes surface hydroxyl groups after de-acetylation with methanolic sodium methoxide or a similar deprotecting agent. (C): In an alternate approach, a 9-carbon “methyl terminated” silane contributes the inert, nonfunctional LCA, and an 11-carbon “vinyl terminated” silane furnishes terminal surface hydroxyl groups after hydroboraton-oxidation using BH₃.THF and alkaline H₂O₂. In all cases (A-C), the resulting hydroxyl functional groups are distributed stochastically over the surface of the film.

FIGS. 3A, B: (A) contact angles measured for HEBS-silanized substrate and various self-assembled monolayers including 1). 100% methyl silane; 2). 100% methyl silane/BH3-H₂O₂; 3). 1:1 Methyl/Vinyl silane; 4). 1:1 Methyl/Vinyl silane/BH₃—H₂O₂; 5). 100% vinyl silane; and 6). 100% vinyl silane/BH₃—H₂O₂. (B) contact angles measured for various self-assembled monolayers including 1). 100% methyl silane; 2). 100% methyl silane/BH₃—H₂O₂; 3). 0.5% vinyl silane; 4). 0.5% vinyl silane/BH₃—H₂O₂; (5) 2% vinyl silane; (6) 2% vinyl silane/BH₃—H₂O₂; (7) 4% vinyl silane; (8) 4% vinyl silane/BH₃—H₂O₂.

FIG. 4: Observed surface hydroxyl site densities in a series of SAMS as a function of the input ratio of vinyl silane precursor to nonfunctional “methyl-terminated” silane after hydroboration-oxidation. The measured hydroxyl content increases in proportion to the input ratio of the vinyl component. When more than 10% (mole fraction) vinyl groups are incorporated, the observed hydroxyl values appear to approach an asymptote rather than continuing to increase monotonically. Steric crowding of the surface groups is likely limiting their accessibility to the analysis which requires bimolecular reactions to covalently attach a fluorescent label.

FIGS. 5A, B: Evaluation of oligonucleotide synthesis efficiency on hydroxylated monolayers that were prepared via 2%- and 4%-vinyl terminated SAMs, as described in Example 6. A labeled hexathymidylate sequence was synthesized on the substrates, cleaved, and then analyzed by HPLC. The overall density of sequences synthesized (site density); the relative yield of full-length hexamer; and the average stepwise cycle efficiency over six steps is reported. For reference, values for a HEBS-based substrate coating (denoted “1:99”) are also shown. Two synthesis chemistries were evaluated: (A), standard tritylation chemistry using DMT phosphoramidites; and (B), photolithographic synthesis using photolabile NNPOC phosphoramidites.

FIGS. 6A, B: Evaluation of SAM stability in phosphate buffer, pH 7.2 at 45° C. (A) Bright stripes represent surface fluorescence from a fluorescein label that has been covalently attached to the terminal hydroxyls of a SAM derived from 1:1 mixture of methyl- and vinyl terminated alkyltrichlorosilanes as described in Example 7. Degradation of the surface layer over time is reflected by decreasing fluorescence intensity. (B) Plot of numerical fluorescence data extracted from the images in (A). These observations demonstrate that the SAM surface coating is at least as the HEBS-based coating over prolonged exposure to aqueous phosphate buffer at elevated temperature.

FIG. 7: Stability of hybridization signal for probe sequences synthesized on self-assembled monolayer surfaces with various hydroxyl functional site density. It is apparent that SAM substrates showed very stable fluorescent signal due to bound, hybridized targets with complementary sequences, over extended periods of time in aqueous MES buffer, pH 6.8 at 45° C. Exceptions are the SAMs with very low (0.5%) or very high (>50%) hydroxyl content, which showed hybridization signals decreasing and increasing with time, respectively. The latter effect is due to a retardation of the hybridization kinetics resulting from the very high density of surface probe molecules (A W Peterson, et al. Nucl. Acids Res. 2001, 29:5163-8).

FIG. 8: Preparation of single- and multi-layer SAMs prepared from 100% 11-acetoxyundecyltrichlorosilane, as described in Example 1.

FIGS. 9A, B, C: Comparison of stability of single- and multilayer SAMs prepared from 100% 11-acetoxyundecyltrichlorosilane in, (A) 6×SSPE buffer at 45° C.; and (B) 150 mM NaOH at 22° C., based on surface fluorescence. The results demonstrate that multilayer films are much more resistant towards degradation in aggressive aqueous environments. Data for HEBS is included for comparison.

FIG. 10: Kinetics of hybridization of a 20-mer oligonucleotide target sequence to an ATRP 2c polymer brush coating containing a 10% mole fraction of hydroxyethylacrylate in a two-component mixture with the non-functional monomer methoxyethylmethacrylate. Hybridization protocols are described in Example 6.

FIG. 11: Hydroxyl density of co-polymer brush coatings (ATRP-2c polyacrylate) can be controlled by varying the mole fraction of functional hydroxyethylacrylate in a two-component mixture with the non-functional monomer methoxyethylmethacrylate.

FIG. 12: Comparison of stability of co-polymer brush coatings (ATRP-2c polyacrylate) containing a 10% mole fraction of hydroxyethylacrylate in a two-component mixture with the non-functional monomer methoxyethylmethacrylate. (A) in 6×SSPE buffer at 45° C.; and (B) in 150 mM NaOH at 22° C. These results demonstrate that functional polymer brush coatings multilayer films are extremely stable towards aggressive aqueous environments. Data for HEBS is included for comparison.

FIGS. 13A-C: Exemplary SAM linkers. A. 2-Bromo-2-methyl-N,N-Bis-(3-trimethoxysilanylpropyl)propionamide (bromoisobutyrl bis silane or “BiBS”), B. 11-acetoxy undecyl trichloro silane, C. 11-[(2-bromo, 2-methyl) propionyloxy]undecyl trichloro silane.

FIG. 14: Exemplary extension linkers.

FIG. 15: Reaction scheme for generating a fluorinated combined SAM-extension linker.

FIG. 16: Scheme for measuring density of reactive sites or coupling efficiency to such sites.

FIG. 17: Preparation of a polyacrylamide co-polymer brush coating ATRP-1a from functional and nonfunctional acrylamide.

### SUMMARY OF THE CLAIMED INVENTION

The present application provides methods of synthesizing a polymer array. The methods comprise (a) contacting a surface of a substrate with at least one linker, wherein the linker has a backbone chain comprising at least 5 carbon atoms with a head group at one end and a functional tail group precursor at the other end, wherein molecules of the linker self-assemble in a monolayer on the surface of the substrate; (b) converting the functional tail group precursor into a functional tail group; and synthesizing a polymer array monomer-by-monomer on the monolayer wherein the first monomers of the polymers attach to the monolayer via the functional tail group of the linker molecules. In some methods, the converting comprises deprotecting, activating or substituting the functional tail group precursor. In some methods, the polymer array is a nucleic acid array. In some methods, the at least one linker comprises a functional linker and a nonfunctional linker, the functional linker being the linker with the head group, functional tail group precursor and backbone of at least five carbon atoms and the nonfunctional linker having a backbone chain of at least five carbon atoms, a head group and no tail group.

Some methods further comprise (d) contacting the monolayer with a mixture of an extension linker having a head group and a tail group and a capping agent having a head group and lacking a tail group, wherein the extension linker and the capping agent attach to molecules of the linker molecule via bonding of the head groups of the extension linker and the capping agent and the tail group of the extension linker. The first monomers of the polymers attach via the tail group of the extension linker. In some methods, the tail group of the extension linker is protected or inactivated and the method further comprises deprotecting or activating the tail group before the first monomers attached to it. In some methods, the extension linker molecule is a phosphoramidite-PEG linker. In some methods, the phosphoramidite-PEG linker is protected, and the method further comprises deprotecting the phosphoramidite-PEG linker to generate a terminal hydroxyl tail group. In some methods, the phosphoramidite-PEG linker comprises deoxycitidine-PEG. In some methods, the ratio of phosphoramidite PEG linker to the capping molecule is 1:5. In some methods, the ratio of phosphoramidite PEG linker to the capping molecule is 1:10.

In some methods, the backbone chain comprises at least 10 carbon atoms. In some methods, the backbone chain has 5-20 carbon atoms. In some methods, the backbone chain has 9-15 carbon atoms. In some methods, the backbone chain is an alkane chain. In some methods, the backbone is an alkene chain. Some methods further comprise cross-linking the alkene chains of an assembled monolayer, whereby the alkene chain are converted to cross-linked alkane chains. In some methods, the alkane is unbranched. In some methods, the silane group is trichlorosilane. In some methods, the silane group is trimethoysilane. In some methods, the silane group is triethoxysilane. In some methods, the silane group is dialkylamino silane. In some methods, the head group is a silane group, which covalently binds to a hydroxyl group on the surface of the substrate. In some methods, the monolayer forms a contact angle with water of 40-120 degrees. In some methods, the tail group is vinyl. In some methods, the tail group is acetyloxy. In some methods, the tail 1 group is a thiol. In some methods, the tail group is an azido group. In some methods, the deprotecting or activating converts the functional group to a hydroxyl group. In some methods, the deprotecting or activating comprises treating the functional group with NaOH. In some methods, the linker is contacted with the surface in a liquid solvent. In some methods, the linker is contacted with the surface as a solventless vapor.

The present application also provides methods of derivatizing a surface of a substrate. The methods comprise (a) contacting a surface of a substrate with at least one linker wherein the linker has a backbone chain comprising at least 5 carbon atoms with a head group at one end, and a functional tail group precursor at the other end, wherein molecules of the one or more linker self-assemble in a first monolayer on the surface of the substrate; (b) converting the functional tail group precursor into a functional tail group; and (c) repeating step (a) such that a second monolayer of a second linker having a backbone of at least five carbon atoms, a head group and a tail group assembles on top of the first monolayer via linking of the head group on the second linker molecules of the second monolayer to the functional tail group of the linker molecules of the first monolayer. In some methods, the converting comprises deprotecting, activating or substituting the functional tail group precursor. Some methods further comprise (d) converting the functional tail group precuisor of the second linker into a functional tail group; and (e) synthesizing a polymer array on top of the second monolayer, wherein the first monomer of the polymers attaches via the functional tail group of the second linker. In some methods, the nucleic acids are synthesized monomer-by-monomer. Some methods further comprise repeating step (c)) n times such that n+1 monolayers are successively assembled on top of one another, and the polymer nucleic acid array is assembled on top of the n+1th monolayer linked to the tail group of the linker molecules of the nth monolayer.

The present application also provides methods of derivatizing a support. The methods comprise linking molecules of an initiation linker to a surface of a support, the initiation linker having a polymerization initiator distal to the surface; and extending the initiation linker by atom transfer radical polymerization using a mixture of a first monomer and a second monomer. The first monomer has a functional group absent from the second monomer, the polymerization initiator initiates polymerization and monomers are incorporated into a polymer molecules extending from the initiation linker. the first monomer and the second monomer are selected from

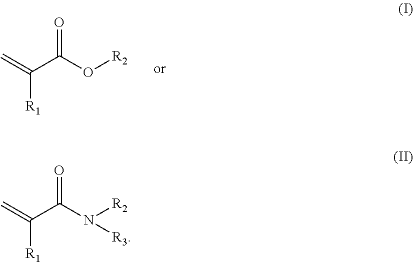

R₁ is hydrogen or lower alkyl; R₂ and R₃ are independently hydrogen, or —Y—Z, wherein Y is lower alkyl, and Z is hydroxyl, amino, or C(O)—R, where R is hydrogen, lower alkoxy or aryloxy. Some methods further comprise synthesizing a polymer array on the polymer molecules wherein the array polymers attach via the functional group on the first monomer molecules incorporated into the polymer molecules.

The present application also provides methods of derivatizing a support. The methods comprise linking molecules of an initiation linker to a surface of a support, the initiation linker having a polymerization initiator distal to the surface; and extending the initiation linker by atom transfer radical polymerization using a first mixture of a first monomer and a second monomer, followed by a second mixture of a third monomer and a fourth monomer, thereby forming two segments. The first segment synthesized using the first mixture and the second segment is synthesized using the second mixture. The second segment is synthesized after the first segment. The first monomer and the third monomer have a functional group absent from the second monomer and the fourth monomer. The polymerization initiator initiates polymerization and monomer molecules are incorporated into a polymer molecules extending from the initiation linker. The monomers are selected from

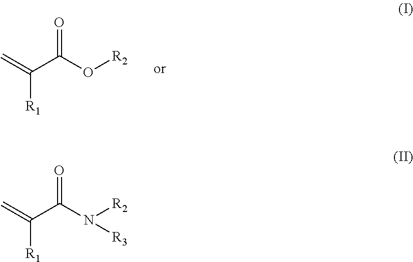

R₁ is hydrogen or lower alkyl; R₂ and R₃ are independently hydrogen, or —Y—Z, wherein Y is lower alkyl, and Z is hydroxyl, amino, or C(O)—R, where R is hydrogen, lower alkoxy or aryloxy. Some methods further comprise synthesizing a polymer array on the polymer molecules wherein the array polymers attach to the functional group on first and third monomer molecules incorporated in the polymer molecules. In some methods, the first monomer and the second monomer are compounds of formula (II). In some methods, the third monomer and the fourth monomer are compounds of formula (I). In some methods, the mixture of the third monomer and the fourth monomer is a mixture of compounds of formula (I) and formula (II). In some methods, the density of polymer molecules in the first segment is higher than that of the second segment.

The present application also provides methods of derivatizing a support. The methods comprise (a) contacting a surface of a substrate with at least one linker wherein the linker has a backbone chain comprising at least 5 carbon atoms with a head group at one end; and (b) extending the linker molecules of the monolayer by atom transfer radical polymerization using a mixture of a first monomer and a second monomer. The linker molecule has a polymerization initiator. Molecules of the at least one linker self-assemble in a monolayer on the surface of the substrate. The first monomer has a functional group lacking in the second monomer. The polymerization initiator initiates polymerization and monomer molecules are incorporated into a polymer molecules extending from the at least one linker of the monolayer. The first monomer and the second monomer are selected from

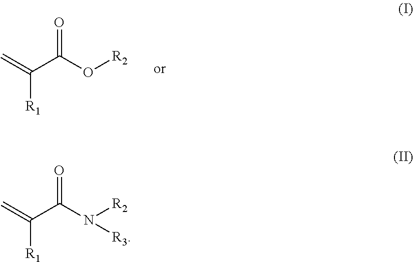

R₁ is hydrogen or lower alkyl; R₂ and R₃ are independently hydrogen, or —Y—Z, wherein Y is lower alkyl, and Z is hydroxyl, amino, or C(O)—R, where R is hydrogen, lower alkoxy or aryloxy.

The present application also provides methods of derivatizing a support. The methods comprise (a) contacting a surface of a substrate with at least one linker, wherein; (b) converting the functional tail group precursor into a functional tail group; (c) contacting the monolayer with an extension linker having a head group or a capping agent having a head group; and (d) extending the extension linker by atom transfer radical polymerization using a mixture of a first monomer and a second monomer. The linker has a backbone chain comprising at least 5 carbon atoms with a head group at one end and a functional tail group precursor at the other end. Molecules of the linker self-assemble in a monolayer on the surface of the substrate. The extension linker and the capping agent attach to molecules of the linker of the monolayer via bonding of the head groups and the functional tail group of the linker molecules. The extension linker has or is provided with a polymerization initiator. The first monomer has a functional group lacking in the second monomer and the polymerization initiator initiates polymerization and monomer molecules are incorporated into a polymer molecules extending from the extension linker molecule. The first monomer and the second monomer are selected from

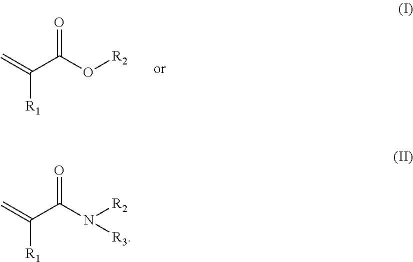

R₁ is hydrogen or lower alkyl; R₂ and R₃ are independently hydrogen, or —Y—Z, wherein Y is lower alkyl, and Z is hydroxyl, amino, or C(O)—R, where R is hydrogen, lower alkoxy or aryloxy.

The present application also provides methods of derivatizing a support. The methods comprise (a) contacting a surface of a substrate with at least one linker; (b) converting the functional tail group precursor into a functional tail group; (c) repeating step (a) such that a second monolayer of a second linker having a backbone of at least five carbon atoms, a head group and a tail group assembles on top of the first monolayer via linking of the head group on the second linker molecules of the second monolayer to the functional tail group of the linker molecules of the first monolayer; and (d) extending the linker molecules of the second monolayer by atom transfer radical polymerization using a mixture of a first monomer and a second monomer. The linker has a backbone chain comprising at least 5 carbon atoms with a head group at one end, and a functional tail group precursor at the other end. Molecules of the one or more linker self-assemble in a first monolayer on the surface of the substrate. The linker molecules of the second monolayer have or are provided with a polymerization initiator. The first monomer has a functional group lacking in the second monomer. The polymerization initiator initiates polymerization and monomer molecules are incorporated into a polymer molecules extending from the linker molecules of the second monolayer. The first monomer and the second monomer are selected from

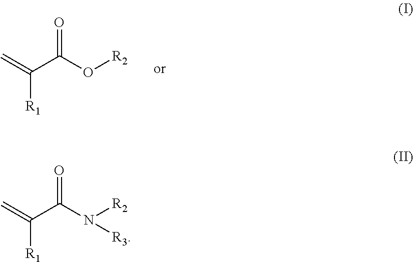

R₁ is hydrogen or lower alkyl; R₂ and R₃ are independently hydrogen, or —Y—Z, wherein Y is lower alkyl, and Z is hydroxyl, amino, or C(O)—R, where R is hydrogen, lower alkoxy or aryloxy.

Optionally, methods of derivatizing a support further comprise synthesizing a polymer array on the polymer molecules wherein the array polymers attach to functional groups of the first monomer molecules in the polymer molecules. In some methods, the nucleic acids are synthesized monomer-by-monomer. In some methods, the functional groups are hydroxyl groups. In some methods, multiple nucleic acid molecules attach to multiple hydroxyl groups of the same polymer molecule. In some methods, the initiation linker is N-(2-hydroxyethyl)-N,N-bis(trimethoxysilylpropyl)amine (HEBS). In some methods, the extension linker molecule is a phosphoramidite-PEG linker. In some methods, the capping agent is a phosphoramidite-unicap. In some methods, the linker is an alkyl-silane having at least 9 carbon atoms. In some methods, the initiator is linked to the linker before linking molecules of the silane linker to the surface of the support. In some methods, the initiator is linked to the linker after linker molecules are linked to the surface of the support. In some methods, the first monomer and the second monomer are compounds of formula (I). In some methods, the first monomer and the second monomer are

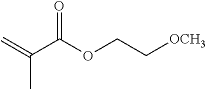

and

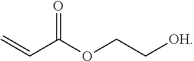

In some methods, the mixture of the first monomer and the second monomer is a mixture of compounds of formula (I) and formula (II). In some methods, the monomer is hydroxyethyl or methyl acrylamide. In some methods, the polymer molecules are 30-1000 Å long. In some methods, the polymers have 10-50 monomers linked in a chain. In some methods, the mixture of the first monomer and the second monomer contains 1-100% the first monomer and 99-0% the second monomer. In some methods, the mixture of the first monomer and the second monomer contains 5-50% the first monomer and 95-50% the second monomer. In some methods, the mixture of the third monomer and the fourth monomer contains 1-100% the first monomer and 99-0% the second monomer. In some methods, the mixture of the third monomer and the fourth monomer contains 5-50% the first monomer and 95-50% the second monomer.

### DEFINITIONS

A self-assembling monolayer (SAM) is a term of art that refers to a three-dimensional structure in which two dimensions occupy a surface of a support and the third dimension is a single molecule thick extending from the support (see, e.g., Luderet et al., Top. Curr. Chem. (2005) 260: 37-56). The molecules in a monolayer have backbone, a head group at one end of the backbone and often a tail group at the other end of the backbone. The molecules are regularly spaced and orientated substantially parallel to one other with the head groups contacting the surface and the tail groups (if present) orientated away from the surface. The monolayer is held together by van der Waals forces between methylenes in the backbone, other intermolecular noncovalent bonding between backbones such as between fluorocarbons, by bonds formed between head groups, and/or by noncovalent interactions between tail groups. Monolayers form spontaneously when suitable molecules are deposited on a surface in solution or vapor phase. The head groups initially form a noncovalent association with the surface but may form covalent bonds as assembly progresses. Self-assembled monolayers of n-alkylsilanes and other linkers can be recognized by their dense, ordered and uniform coverage, as characterized by the application of techniques such ellipsometry, contact angle, atomic force microscopy (AFM), attenuated total reflectance-Fourier transform infrared spectrometry (ATR-FTIR); x-ray photoelectron spectrometry (XPS), X-ray diffraction (see, e.g., Sagiv J. J. Am. Chem. Soc. 1980, 102:92; Wasserman, et al. J Amer Chem Soc 1989, 111:5852; Tidswell, et al. J Chem Phys, 1993, 98:1754; Parikh, et al. J. Phys Chem 1995, 99: 9996; Ulman Chem Reviews 1996, 96:1533; Stevens, Langmuir 1999, 15:2773; Wang, Lieberman, Langmuir 2003, 19:1159; Booth, et al., Langmuir 2009, 25:9995).

A monomer is a member of a set of molecules that can be joined together to form an oligomer or polymer. The set of monomers useful in the invention includes nucleotides and nucleosides for nucleic acid synthesis and the set of L-amino acids, D-amino acids, or synthetic amino acids for polypeptide synthesis. The set of monomers useful in the invention also includes any member of a basis set for synthesis of other polymers such as polyacrylate, polyacrylamide, polysaccharides, phospholipids, heteropolymers, polyurethanes, polyesters, polycarbonates, polyureas, polyamides, polyethyleneimines, polyarylene sulfides, polysiloxanes, polyimides, polyacetates, or other polymers which will be apparent on review of this disclosure, or co-polymer thereof. Different basis sets of monomers may be used at successive steps in the synthesis of a polymer.

Monomers also include acrylate and acrylamide monomers, e.g., monomers having the following general structure:

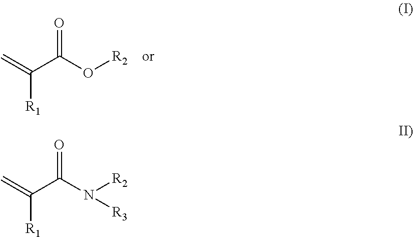

in which R₁ is hydrogen or lower alkyl; R₂ and R₃ are independently hydrogen, or —Y—Z, wherein Y is lower alkyl, and Z is hydroxyl, amino, thiol or other functional group or protected form thereof.

A nucleic acid is a polymeric form of nucleotides of any length, either ribonucleotides, deoxyribonucleotides or peptide nucleic acids (PNAs) or (Locked nucleic acids, LNAs), that include purine and pyrimidine bases, or other natural, chemically or biochemically modified, non-natural, or derivatized nucleotide bases. Nucleic acids can be single or double stranded. The backbone of the nucleic acid can include sugars and phosphate groups, as may typically be found in RNA or DNA, or modified or substituted sugar or phosphate groups. A nucleic acid may include modified nucleotides, such as methylated nucleotides and nucleotide analogs. The sequence of nucleotides may be interrupted by non-nucleotide components. Thus the terms nucleoside, nucleotide, deoxynucleoside and deoxynucleotide generally include analogs such as those described herein. These analogs are those molecules having some structural features in common with a naturally occurring nucleoside or nucleotide such that when incorporated into a nucleic acid or oligonucleotide sequence, they allow hybridization with a naturally occurring nucleic acid sequence in solution. Typically, these analogs are derived from naturally occurring nucleosides and nucleotides by replacing and/or modifying the base, the ribose or the phosphodiester moiety. The changes can be tailor made to stabilize or destabilize hybrid formation or enhance the specificity of hybridization with a complementary nucleic acid sequence as desired.

Nucleic acids can be isolated from natural sources, recombinantly produced or artificially synthesized and mimetics thereof, such as LNA, “Locked nucleic acid”. A further example of a nucleic acid is a peptide nucleic acid (PNA). Double stranded nucleic acid usually pair by Watson-Crick pairing but can also pair by Hoogsteen base pairing which has been identified in certain tRNA molecules and postulated to exist in a triple helix. The term “oligonucleotide” refers to a nucleic acid of about 7-100 bases, (e.g., 10-50 or 15-25).

A substrate is a material or group of materials having a rigid, semi-rigid surface or flexible surface suitable for attaching an array of polymers, particularly an array of nucleic acids. Suitable materials include polymers, plastics, resins, polysaccharides, silica or silica-based materials, carbon, metals, inorganic glasses, membranes. The surface can be the same or different material as the rest of the substrate. In some substrates, at least one surface of the substrate is flat, although in some substrates it may be desirable to physically separate synthesis regions for different compounds with, for example, wells, raised regions, pins, etched trenches, or the like. The substrate can take the form of beads, resins, gels, microspheres, or other geometric configurations. (See, U.S. Pat. Nos. 5,744,305, 7,745,091, 7,745,092 and U.S. Patent Application Publication Nos. US20100290018, US20100227279, US20100227770, US20100297336, and US20100297448 for exemplary substrates and microspheres, which are hereby incorporated by reference herein in its entirety for all purpose).

The singular form “a,” “an,” and “the” include plural references unless the context clearly dictates otherwise. The term “an agent,” for example, includes a plurality of agents, including mixtures thereof.

Descriptions in range formats are provided merely for brevity and should not be construed as an inflexible limitation on the scope of the invention. Accordingly, the description of a range should be considered to have specifically disclosed all the possible sub-ranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6, etc., as well as individual numbers within that range, for example, 1, 2, 3, 4, 5, and 6. This applies regardless of the breadth of the range.

The term “lower” in reference to a carbon chain such as in lower alkyl means a chain of one to four carbon atoms.

### DETAILED DESCRIPTION

### I. General

The present invention provide several methods of derivatizing a surface of a support with one or more linkers thus providing a suitable platform for synthesis of a polymer array, particular a nucleic acid array. Some methods derivatize a surface with a self-assembled monolayer (SAM) of a linker. The linker has a head group that attaches to the surface and a precursor of a tail group that provides an attachment point for array synthesis. A polymer array can be synthesized in a monomer-by-monomer fashion on the SAM with the first monomers of the polymers attaching directly or indirectly via the tail group of the linkers. The uniformity and tight packing of a SAM confers advantages of hydrolytic stability and broad compatibility with synthesis and detection chemistries. The SAM layer also permits control of polymer density in an array either by using a mixture of functional and nonfunctional linkers or subsequently treating the same with a mixture of a functional extension linker and nonfunctional capping group. For the purposes of fabricating oligonucleotide probe arrays, it is typically advantageous to attach a functionalized hydrophilic “extension linker” molecule to the surface hydroxyl groups of silanated substrates prior to synthesizing the oligonucleotide probe array (Southern E M, et al. Genomics 1992, 13:1008-17; Pease A C, et al. Proc. Natl. Acad. Sci. USA 1994, 91, 5022-26.)

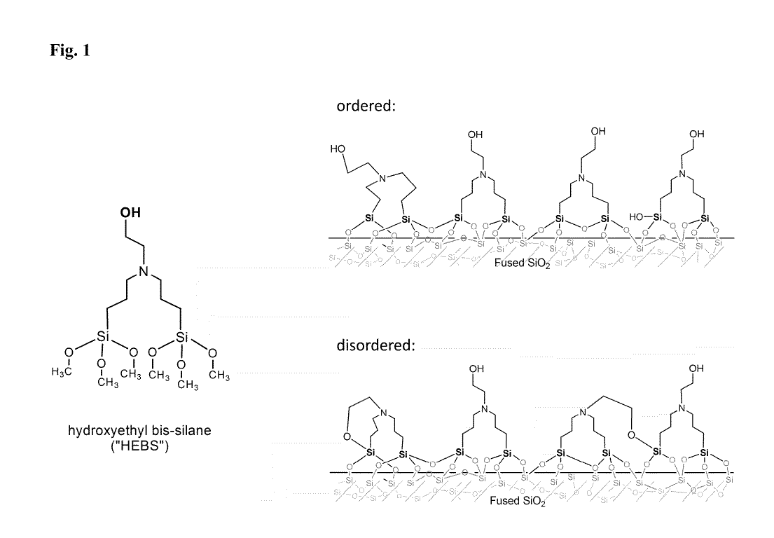

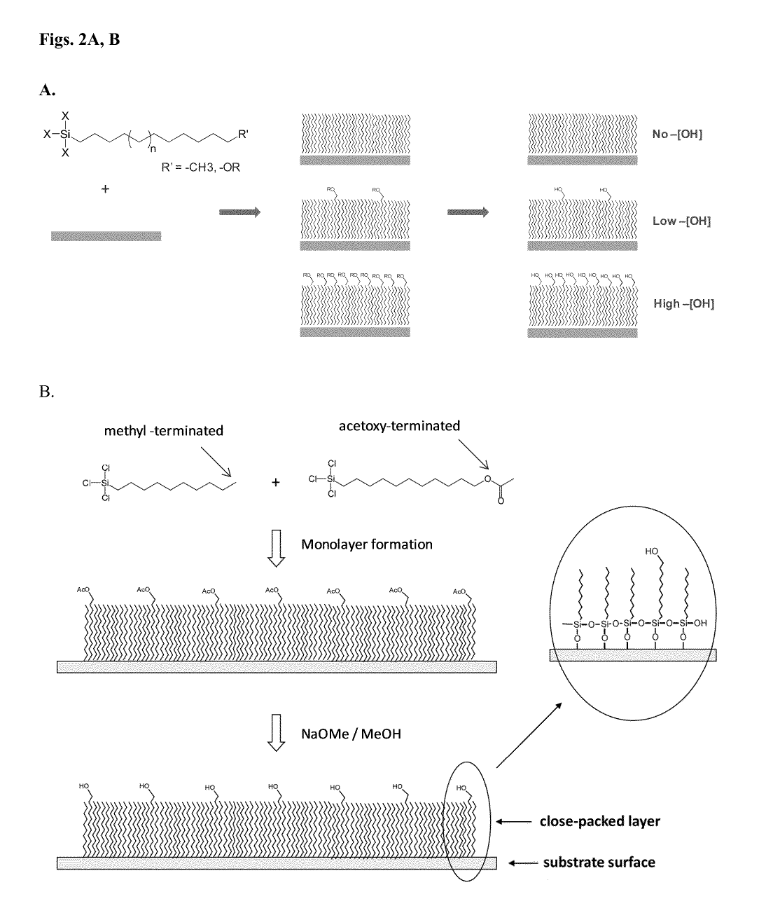

The uniformity of the SAM also avoids emergence of latent functional groups and new starts sites during polymer synthesis as may occur with linkers previously used in array synthesis. Using conventional platforms, a complex surface polysiloxane network can re-organizes during array synthesis, and new hydroxyl sites emerge during the reorganization (FIG. 1 right). When a polymer array is synthesized on a support derivatized in this manner, incoming monomers intended to be added to nascent polymer chains may instead attach directly to latent functional groups of the support reducing the efficiency of coupling and giving rise to polymers of spurious sequence. The use of a SAM reduces or eliminates latent functional groups by presenting a substantially uniform layer of tail groups on a surface, equally accessible to react in subsequent steps.

In some methods, substrate surfaces are derivatized with multi-layers of SAMs. In a multi-layer SAM, one monolayer is synthesized over another. The multi-layers can confer even greater hydrolytic stability than a single monolayer. Multi-layer SAMs can be used for synthesis of polymer arrays in a monomer-by-monomer manner or by direct attachment. As many as 2, 3, 4, 5, 6 or even 7 multi-layers can be employed.

In some methods, substrate surfaces are derivatized by synthesizing a linker in situ on the surface by atom transfer radical polymerization of first and second monomers. The first monomer has a functional group not present in the second monomer. The functional group on molecules of the first monomer incorporated into the chain provides an attachment site for polymer synthesis.

### II. Self-Assembled Monolayers

### 1. Linkers

A self-assembled monolayer includes at least one type of linker. This linker has a backbone chain of carbon atoms, a head group at one end of the backbone for attachment to the surface of a substrate and a tail group at the other end to provide a support for polymer array synthesis. This linker is sometimes referred to as a functional linker or functional SAM linker in distinction from a non-functional linker, which can form a SAM but lacks a tail group to provide a site for further attachment. Array polymers can attach directly to the tail group or indirectly via an extension linker of the functional SAM linker. The tail group is preferably protected or inactivated or otherwise in precursor form during formation of the monolayer but deprotected or activated or otherwise rendered functional before array synthesis or attaching an extension or ins situ synthesized linker.

### (a) Backbone Chain

The backbone chain is preferably an alkane chain, but can be an alkene chain or an alkyne chain. These terms are used in accordance with convention. An alkane is a saturated hydrocarbon molecule. An alkene is an unsaturated hydrocarbon molecule includes one or more carbon-carbon double bonds. An alkyne is an unsaturated hydrocarbon molecule including one or more carbon-carbon triple bonds. If double or triple bonds are present they preferably constitute no more than 20% of the carbon bonds in the backbone chain.

The backbone is preferably unsubstituted (except for head and tail groups on the terminal carbon atoms as described further below) but can be a substituted backbone chain with one or more of its hydrogen atoms replaced by one or more substituent groups, such as, for example, halo groups, particularly, fluoro, hydroxy groups, alkoxy groups, carboxy groups, thio groups, alkylthio groups, cyano groups, nitro groups, amino groups, alkylamino groups, dialkylamino groups, silyl groups, and siloxy groups. Preferred substituents include the substitution of one or more hydrogen atoms in the backbone chain with one or more fluorine atoms. Fluorinated backbone chains can confer greater stability in the mono-layer than hydrocarbon backbone chain. Preferably any substitutions other than the terminal head and tail groups and other than fluorines are no more than 5, 4, 3, 2, or 1.

The backbone chain is preferably all carbon atoms but can also be a heteroatom in which one or more of its internal carbon atoms are replaced by one or more heteroatoms, such as, for example, N, Si, S, O, and P. Examples of hetero alkane, a hetero alkene, or a hetero alkyne include polyethyleneglycol (PEG), N-(2-aminoethyl)-3-aminopropyltrimethoxysilane (EDA) or polymer thereof, and trimethoxysilylpropyldiethylenetriamine (DETA) or polymer thereof. Preferably the number of heteroatoms if any in the background chain is no more than 20% of the number of carbon atoms in the backbone chain. Preferably, the number of heteroatoms is no more than 2 or 1 and is preferably 0. Non-carbon atoms present in the head or tail groups (e.g., Si, O or CO at the ends of the backbone chain are considered to be part of the head or tail group rather than a heteroatom in the chain.

The backbone chain is preferably unbranched. If any branching is present, the branching preferably confined to the carbon atom at the tail end of the linker.

Branched or otherwise substituted backbones are not preferred due to potential disruptive effects on the ordered packing of the hydrocarbon chains. However, these backbones can be used if their effects can be tolerated, particularly when the unsaturated groups or substituents are on the carbon at the tail end of the backbones chain, or when they serve as functional or modifiable groups for modulating surface energy or for the attachment of an extension linker or surface polymerization initiator moiety.

The backbone chain can have a combination of characteristics listed above. For example, the backbone chain can be substituted or unsubstituted, with or without a heteroatom and with or without branching at the tail end carbon. However, any departures from a straight chain alkane preferably do not result in groups reactive with monomers, or extension linkers in subsequent synthesis steps and do not interfere with assembly of a monolayer.

The backbone chain can include from 3 to 100 carbon atoms. Some backbone chains include at least 8, 9, 10, 11, 15 or 20 carbon atoms. Some backbone chains include 5-25 or 7-20 or 9-15 carbon atoms. Some backbone chains include more than 20 carbon atoms, such as from 21 to 100 carbon atoms, from 21 to 40 carbon atoms, from 41 to 60 carbon atoms, from 61 to 80 carbon atoms, from 81 to 100 carbon atoms.

### (b) Head Group

The linker molecules associate with and bind to the surface of a substrate via a head group. The binding can be due to hydrophobic interactions, chelation or ionic interaction, or can be a covalent bond. Examples of covalent bonds include a Si—O bond, e.g., formed between an alkoxysilane group and a hydroxyl group glass substrate. Other useful head group-substrate combinations include gold/thiol, silver/thiol, metal oxide/fatty acid, and phosphate/phosphonate. A class of monolayer is based on the strong adsorption of thiols (R—SH), disulfides (R—S—S—R) and sulfides (R—S—R) onto metal surface (e.g., gold, silver, platinum, copper). For example, thiols interact with gold or silver interfaces to form a sulfide bond. Carboxyl binding groups of fatty acids can associate, possibly through the formation of ionic bonds, with a metal oxide interface on a substrate to promote the assembly of a monolayer. Phosphonates can interact with metals chelated at the surface of a solid supported phosphate to form a monolayer.

The head group is preferably a silane group, which is reactive with a group on the surface of the substrate, e.g., a hydroxyl group on a substrate. Some silane groups have a formula: (R¹)Si(R²)(R³)(R⁴), in which R¹ is the backbone chain, and at least one of R², R³, R⁴ represents a monovalent hydrolysable group, which can independently include a halogen atoms, alkoxy group, acyloxy group, oxime group and amino group. Preferably, the silane group is a group having formula (I): (R¹)Si(R²)₃, in which R¹ is the backbone chain, and R² represents monovalent hydrolysable group, which can include a halogen atoms, alkoxy group, acyloxy group, oxime group and amino group. Preferably, the alkoxy group has 1 to 6 carbon atoms. Such alkoxy group can include a methoxy group, ethoxy group, propoxy group, isopropoxy group, butoxy group and isobutoxy group. Examples of silane group include trichlorosilane, trimethoxysilane, triethoxysilane, tripropoxysilane, monoalkyl-dialkoxysilane, monoalkyl-dichloridesilane, methyldichlorosilane, methyldimethoxysilane, methyldiethoxysilane, methyldipropoxysilane, ethyldichlorosilane, ethyldimethoxysilane, ethyldiethoxysilane, propyldichlorosilane, propyldimethoxysilane, phenyldichlorosilane, phenyldimethoxysilane, phenyldiethoxysilane, and dialkylamino silane. Preferably, the silane group is trichlorosilane, trimethoxysilane, triethoxysilane, tris(dialkylamino)silane. Silane groups can initially associate with hydroxyl groups on a surface by reversible covalent bonding allowing rearrangements as the monolayer assemblies and can subsequently form covalent bonds with the surface and with each other locking the monolayer in place when assembly is complete.

### (c) Tail Group

A tail group is a functional group, or a precursor thereof that can be converted into a functional group. The functional group can react to form a covalent bond between the linker molecule and another substance, such as a polymer (e.g., nucleic acid) or an extension linker molecule. Some functional groups (e.g., a hydroxyl group) are capable of reacting with activated nucleotides to permit nucleic acid synthesis. For example, a SAM linker with a hydroxyl tail group (after deprotection) can be covalently attached to the surface of a substrate, such as glass, and then the hydroxyl group deprotected and reacted with an activated phosphate group on a protected nucleotide phosphoramidite or H-phosphonate, followed by the stepwise addition of further protected nucleotide phosphoramidites or H-phosphonates to form a nucleic acid covalently attached via the SAM linker to the support.

Exemplary functional tail groups include, but are not limited to, hydroxy, thiol, amine, hydrazine, aminooxy, sulfonate, sulfate, azide, carbonyl, carboxyl, carboxylate, thiocarboxyl, aldehyde, alkene, alkyne, disulfide, isocyanate, isothiocyanate, as well as modified forms and analogues thereof, such as activated, protected, or other precursor forms. Precursor forms of functional groups also include substitutable leaving groups such as halogen or sulfonyloxy.

Functional tail groups can arise by conversion of a precursor group. For example, a linker molecule having a hydroxyl group can be converted from a linker molecule having a leaving group such as halogen treated with sodium hydroxide. A linker molecule having a hydroxyl group can also be converted from a linker molecule having a vinyl group in anti-Markovnikov reaction or a Markovnikov reaction. Preferably, functional tail group precursors are functional groups in protected or inactivated forms.

Functional tail groups are preferably protected, inactivated or otherwise in precursor form during monolayer formation and deprotected, activated or otherwise rendered functional for subsequent synthesis. In general deprotection of a protected functional group refers to removal of a protecting moiety from the functional group, whereas activation of an inactive functional group refers to adding an activating moiety to the functional group. A deprotected or activated functional group is synthetically equivalent (i.e., a synthon) but is more active than a protected or inactivated functional group. Deprotection and activation are not necessarily mutually exclusive.

Examples of protecting groups include hydroxyl protecting groups. The hydroxyl protecting groups (if present) can be removed under standard conditions. For example, an acetate protecting group can be removed under extremely mild conditions with potassium carbonate. A silyl ether protecting group can be removed by fluoridolysis using TBAF or with mild acid. If these conditions are unsuitable for a particular carbamate, alternative hydroxyl protecting groups can be selected as long as they are capable of surviving the reduction of the nitro group. Other examples of protective groups are provided in the section below on deprotection and activation.

In summary, a SAM linker preferably has a backbone chain of at least 6, 7, 8, 9, 10, 11, 12, 13, 14, 15, 16, 17, 18, 19 or 20 or more contiguous carbon atoms and is preferably a straight chain, unsubstituted, no-heteroatom alkane other than for head and tail groups. Preferred precursor forms of a tail group include acetyloxy or vinyl. Acetyloxy can be converted to hydroxyl by, e.g., alkaline hydrolysis. Vinyl can be converted to hydroxyl by, e.g., treatment with borane tetahydrofuran (BH3-THF) followed by H₂O₂ and sodium hydroxide. Preferably, the tail group in precursor form is acetyloxy (AcO) which is converted to a hydroxyl in active form. Most preferably, the SAM linker molecule is as shown below or linkers of the same structure except with a carbon backbone varying from 6-30, preferably, 8-18 and more preferably 10-16 carbons:

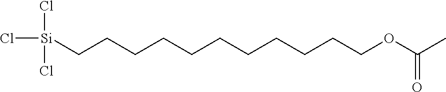 [SMILES: CC(=O)OCCCCCCCCCCC[Si](Cl)(Cl)Cl]

Other preferred SAM linkers conform to the formula:

X₃Si—(CH₂)ₘ—(CF₂)ₙ—(CH₂)ₚ—Y,

wherein
X═Cl; OR, NR₂ (where R=methyl or ethyl); m=0-30; n=0-18; p=0-30; (m+n+p=6-30; preferably 8-18; more preferably 10-16.
Y=hydroxyl, thiol, amine, hydrazine, oxylamine, sulfonate, sulfate, carboxylate, thiocarboxylate, aldehyde, carboxaldehyde, and protected forms thereof; halogen, azide, alkyl- or aryl-disulfide, isocyanate, isothiocyanate, alkene, vinyl, alkyne, oxyalkyl, AcO or oxyaryl.

Other preferred SAM linkers conform to the formula:

X₃Si—(CR^{X}₂)ₘ—Y, wherein Rx is H or F, and m is 6-30; preferably 8-18; more preferably 10-16, and other symbols are as immediately above. Preferably the R^{x}'s on the same carbon are both F or both are H.

### (d) Specific Linker Molecules

Exemplary SAM linker molecules include functionalized silicon compounds (see, e.g., U.S. Patent Application Publication No. 20110143966, which is hereby incorporated by reference herein in its entirety for all purpose). For example, the linker molecules can be compounds of Formula III:

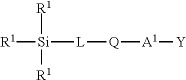

wherein, R¹ is any alkoxy, aryloxy or halogen or is a lower alkyl where at least 1 of the R¹ groups is an alkoxy or halogen; L is a spacer group optionally comprising one or more organofunctional moieties comprising a functional group selected from the group consisting of ether, amine, sulfide, sulfoxyl, carbonyl, thione, ester, thioester, carbonate, thiocarbonate, carbamate, thiocarbamate, amide, thioamide, urea and thiourea group; Q is N, C₁-C₁₀ alkyl or C₁-C₁₀ substituted alkyl, methyl, ethyl, propyl; A¹ is a linking group comprising a straight chain alkyl, branched alkyl, cycloalkyl, alkenyl, alkynyl, aryl or heteroaryl, optionally comprising one or more organofunctional moieties selected from ether, amine, sulfide, sulfonyl, sulfate, carbonyl, thione, ester, thioester, carbonate, thiocarbonate, carbamate, thiocarbamate, amide, thioamide, urea and thiourea group; and Y is a derivatizable functional group or protected functional group selected from the group consisting of halogen, hydroxy, thiol, amine, hydrazine, aminooxy, sulfonate, sulfate, azide, carbonyl, carboxyl, carboxylate, thiocarboxyl, aldehyde, alkene, alkyne, disulfide, isocyanate, isothiocyanate or modified forms thereof.

In some linker molecules, A¹ is a C₃, C₄, C₅, C₆, C₇, C₈, C₉ or C₁₀ straight chain alkyl, or a carboxyl group. In some linker molecules, L is an aliphatic chain comprising at least two carbon atoms, e.g., a carbon chain having 3, 4, or 5 carbon atoms. In some linker molecules, Q is N, and A¹ and Y together, form the group

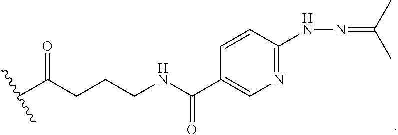 [SMILES: *C(=O)CCCNC(=O)c1ccc(NN=C(C)C)nc1]

In some linker molecules, A¹ is —C(═O)CH₂CH₂NHC(═O)— and Y is 2-(2-(propan-2-ylidene)hydrazinyl)pyridine.

In some linker molecules, each L group is a carbon chain having 3, 4, or 5 carbon atoms, Q is N, and A¹ and Y together, form the group

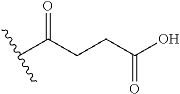 [SMILES: *C(=O)CCC(=O)O]

In some linker molecules, A¹ is a C₃ straight chain alkyl comprising a carboxyl moiety (e.g., —C(═O)CH₂CH₂—) and Y is COOH. In some linker molecules, each L group has 3 carbons.

In some linker molecules, L and A′ are independently selected from —(CH₂)ₙ—, —C(═O)CH₂CH₂—, —CH₂C(═O) —, —CH₂C(═O)NH—, —CH₂C(aromatic ring)NH—. In some linker molecules, when L or A¹ is —(CH₂)ₙ—, the carbon chain defined by n is 2, 3, 4 or 5 atoms long.

The linker molecules can be compounds of Formula IV:

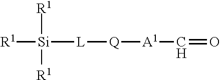

wherein, R¹ is independently any alkoxy, aryloxy or halogen, or is a lower alkyl where at least 1 of the R¹ groups is an alkoxy or halogen; L is independently a spacer group optionally comprising one or more organofunctional moieties comprising functional groups selected from the group consisting of ether, amine, sulfide, sulfoxyl, carbonyl, thione, ester, thioester, carbonate, thiocarbonate, carbamate, thiocarbamate, amide, thioamide, urea and thiourea groups; Q is N, C₁-C₁₀ alkyl or C₁-C₁₀ substituted alkyl; and A¹ is a linking group comprising straight chain or branched alkyl, cycloalkyl, alkenyl, alkynyl, aryl or heteroaryl; optionally comprising one or more organofunctional moieties selected from the group consisting of ether, amine, sulfide, sulfonyl, sulfate, carbonyl, thione, ester or thioester, carbonate or thiocarbonate, carbamate or thiocarbamate, amide or thioamide, urea and thiourea groups.

In some linker molecules, Q is N, methyl, or ethyl. In some linker molecules, L is an aliphatic chain comprising at least two atoms.

The linker molecules can be compounds of Formula V.

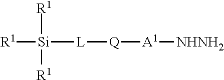

wherein, R¹, L, Q and A¹ are defined as provided for Formula IV.

In some linker molecules, L is methyl, ethyl or propyl. In some linker molecules, Q is methyl, ethyl or propyl. In some linker molecules, N, A¹, and Y together, form the group:

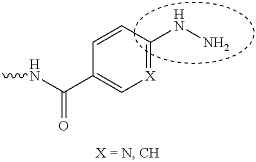

The linker molecules can be compounds of Formula VI.

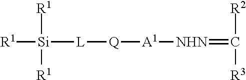

wherein, R¹, L, Q and A¹ are defined as provided for Formula IV and R² and R³ are independently selected from H, alkyl, substituted alkyl, cycloalkyl and substituted cycloalkyl.

### 2. Non-Functional SAM Linkers

As previously mentioned, more than one type of linker can be incorporated into a monolayer. If multiple linker types are incorporated, one type can be a functional SAM linker with a head group, backbone chain and tail group as described above, and the other type can be a non-functional linker with a backbone chain and head group and no tail group. Inclusion of the second type of linker allows control of density of functional groups to support synthesis of polymer arrays and consequent density of polymers in such an array. The self-assembled monolayer can include 0-99.9%, e.g., at least 10%, 30%, 50%, 80, 90 or 99% non-functional linking molecules. However, density of functional groups can alternatively be controlled by use of an extension linker and capping agent as further described below. A non-functional linker can be any of the functional SAM linkers identified above without the functional tail group or tail group precursor. A non-functional linker used with a functional linker can be such that the non-functional linker has the same structure as the functional linker except that a functional tail group or functional tail group precursor on the functional linker is replaced by a hydrogen on the nonfunctional linker.

Some preferred non-functional linkers conform to the formula

X₃Si—(CH₂)ₘ—(CF₂)ₙ—(CH₂)ₚ—Y₁,

wherein
X═Cl; OR, NR₂ (where R=methyl or ethyl); m=0-30; n=0-18; p=0-30; (m+n+p=6-30; preferably 8-18; more preferably 10-16, and Y₁═H.

Some preferred non-functional linkers conform to the formula:

X₃Si—(C R^{X}₂)ₘ—Y₁, wherein R^{x} is H or F, and m is 6-30; preferably 8-18; more preferably 10-16, and other symbols are as immediately above. Preferably the two R^{x}'s on the same carbon are both H or both F.

### 3. Monolayer Assembly

The substrate surface is derivatized with functional linker molecules and optionally non-functional linking molecules via the head group of such linkers. Assembly can be initiated by contacting the surface with a solution of functional linker molecules and optionally non-functional linking molecules, e.g., in inert, nonpolar, anhydrous solvents.

Solution deposition generally involves dipping or otherwise immersing the substrate in a solution of the functional linker molecules and optionally non-functional linking molecules. Following immersion, the substrate is generally spun as described for the substrate stripping process, i.e., laterally, to provide a uniform distribution of the solution across the surface of the substrate. Spinning results in a more even distribution of reactive functional groups on the surface of the substrate. Following application of the SAM layer, particularly if the linker has a silane head group, the substrate can be baked to polymerize the silanes on the surface of the substrate and improve the reaction between the silane reagent and the substrate surface. Baking typically takes place at temperatures in the range of from 90° C. to 120° C., with 110° C. being most preferred, for a time period of from about 1 minute to about 10 minutes, with 5 minutes being preferred.

Alternatively the functional and optionally nonfunctional linker molecules are contacted with the surface of the substrate using controlled vapor deposition methods or spray methods. These methods involve the volatilization or atomization of the linker solution into a gas phase or spray, followed by deposition of the gas phase or spray on the surface of the substrate, usually by ambient exposure of the surface of the substrate to the gas phase or spray. Vapor deposition typically results in a more even application of the derivatization solution than simply immersing the substrate into the solution.

The efficacy of the derivatization process, e.g., the density and uniformity of functional groups on the substrate surface, can be assessed by adding a fluorophore which binds the reactive groups, e.g., a fluorescent phosphoramidite such as Fluoreprime™ from Pharmacia, Corp., Fluoredite™ from Millipore, Corp. or FAM™ from ABI, and examining the relative fluorescence across the surface of the substrate.

The assembly process of a self-assembled monolayer involves a combination of Van der Waals interactions among functional linker molecules/non-functional linking molecules, and sometimes interactions among head groups (e.g., formation of silanol bonds) and/or among tail groups of these molecules. The silanation process involves hydrolysis and condensation of silanes, initially non-covalent adsorption of hydrolyzed silanes to the substrate and formation of silanol bonds. The hydrolysis-condensation polymerization reaction of silanes results in a three-dimensional network of silanol bonds. The backbone chain of the functional linker molecules/non-functional linking molecules interact via van der Waals forces with the backbone chains of adjacent linker molecules/non-functional linking molecules to form a tightly packed association.

The backbone chain of the linker molecules (and non-functional linking molecules when used) can be optionally crosslinked using a crosslinking agent. Examples of the crosslinking agent include vulcanizers such as 2-benzothiazolyl disulfide and tetramethylthiuram disulfide. Examples of the crosslinking agent also include the photo-crosslinking agents such as dichromates, chromates, diazocompounds, or bisazide compounds. Examples of bisazide compounds include 4,4′-diazidechalcone, 2,6-di-(4′-azidebenzylidene)cyclohexanone and 2,6-di-(4′-azidebenzylidene)-4-methylcyclohexanone, 4,4′-diazidodiphenylmethane and 2,6-di-(4′-azidobenzal)-4-methylcyclohexanone. If the linker is an alkene, a crosslinking agent can react with the alkene to crosslink the backbone chain. A least a portion of the alkenes in the backbone is converted into alkanes by the crosslinking agent, thereby converting the alkene chain into cross-linked alkane chains.

However, SAMs are typically used without crosslinking among SAM linker molecules.

### III. Multi-Layering Methods

N Tillman, et al. have reported multilayered SAM films produced by layering one hydroxyl-functional LCA silane over another (Langmuir 1989, 5:101).

The present Examples show that layering one SAM over another confers advantages relative to a single SAM including increased hydrolytic stability. A SAM can be applied to an existing SAM (or a multi-layer) after allowing an appropriate time for first or previous SAM to assemble after its deposition (e.g., at least ten minutes after deposition of the linker(s) for the previous SAM, and sometimes at least one hour and sometimes more than 24 hours after deposition, and sometimes up to a week or longer after deposition). The functional tail group precursor of the first or most recently applied SAM is next converted to a functional tail group. For example, vinyl or acetoxy tail groups can be converted to hydroxyalkyl groups by hydroboration, oxidation and methanolysis, respectively. A silane is then applied by solution or vapor deposition to form the next layer. The usual considerations apply in selecting the linker or linkers for the second monolayer as for the first. At least one linker of the next SAM has a head group, a backbone, and functional tail group precursor. The head group links to the exposed functional tail group of the first (or most recently deposited) SAM. The functional tail group precursor of the new SAM layer provides a point of attachment for a polymer array, an extension linker, or another SAM. As well as providing a new SAM layer, the application of a SAM linker to an existing SAM array also can fill in gaps left in the existing SAM array. Thus, for example, in a applying a second SAM, most linker molecules of the second SAM typically attach to functional tail groups of the first SAM, but some linker molecules of the second SAM layer can attach to functional groups on the surface of the support at which there is a gap in the first SAM (i.e., no linker molecule from the first SAM is attached to the support). Filling in the gaps in the first monolayer can contribute to increased hydrolytic stability as can presence of a second or subsequent SAM (FIG. 8).

Although similar considerations apply in selecting a functional or nonfunctional linker in any layer of a multi-layer SAM, the linkers in different layers can be the same or different than each other.

The stability of the monolayers and multi-layers can be measured using methods such as fluoroprime assays described in U.S. Pat. No. 7,176,297 (the content of which is incorporated herein).

### IV. Linker Synthesized In Situ

US 2006/0134672 and U.S. Pat. No. 6,994,964 describe methods of functionalizing a substrate with polymers having functional groups distributed along the polymer chain. An initiation linker is attached to a surface of support to initiate polymerization of two or more different monomers by atom transfer radical polymerization. The linkers synthesized by this approach are referred to as in situ synthesized linkers or polymer brushes.

The present invention provides an improvement over the prior methods by selection of monomer types conferring a reduction in latent functional groups emerging in the course of monomer-by-monomer array synthesis and/or conferring improved hydrolytic stability.

### 1. Initiation Linker Molecules Having a Polymerization Initiator

Initiation linker molecules useful for initiating polymerization of two or more different polymerizable monomers on a surface of support are molecules having a head group at one end and a polymerization initiator at the other end. The head group is of the same types described above for SAM linkers. A polymerization initiator is a compound that can provide a free radical under certain conditions such as heat, light, or other electromagnetic radiation, which can be transferred from one monomer to another and thus propagate a chain of reactions through which a polymer may be formed. The polymerization initiator contains a radical generation site, which is a site on the initiator wherein free radicals are produced in response to heat or electromagnetic radiation. For example, in the case of an azo-type initiator, a radical generation site exists on the carbon atom on each side of the —N═N— moiety.

The polymerization initiator can be located on the head group or can be separated by a spacer from the head group. The spacer can be any entity linking the head group and the polymerization initiator, e.g., a N,N-bis(trimethoxysilylpropyl)amine linker. The spacer can a SAM layer of linker molecules as described above.

Living polymerization is a polymerization process in which growing polymer chains contain one or more active sites that are capable of promoting further polymerization. See U.S. Pat. No. 5,708,102. A general strategy for g living polymerization is to have a chemical species reversibly cap the active center that promotes polymerization. Living free radical polymerizations (e.g., atom transfer radical polymerization) use polymerization initiators (R—X) that can fragment into an alkyl radical (R—) that promotes polymerization of monomers. Living free radical polymerization is a living polymerization process in which chain initiation and chain propagation occur without significant chain termination reactions. Each initiator molecule produces a growing monomer chain which continuously propagates until all the available monomer has been reacted. Living free radical polymerization differs from conventional free radical polymerization in which chain initiation, chain propagation and chain termination reactions occur simultaneously and polymerization continues until the initiator is consumed (see U.S. Pat. No. 5,677,388). Living free radical polymerization facilitates control of molecular weight and molecular weight distribution. Living free radical polymerization techniques, for example, involve reversible end capping of growing chains during polymerization. One example is atom transfer radical polymerization (ATRP). Heat or electromagnetic radiation can be used to produce the radical which initiates the polymerization of monomers. When heat is used, the initial radical can be generated spontaneously at temperatures above 100° C. or can be generated at temperatures under 100° C. by the addition of a small amount of free radical initiator. See, for example, Hawker, Macromolecules, 30:373-82 (1997).

The polymerization is terminated at a desired stage by a polymerization terminator. A polymerization terminator is a compound that prevents a polymer chain from further polymerization. These compounds may also be known as terminators, capping agents or inhibitors. Examples of polymerization terminators include a monomer that has no free hydroxyl groups (see Greszta et al., Macromolecules, 27:638, 1994). One approach to terminate polymerization is to react the growing radicals reversibly with scavenging radicals to form covalent species. Another approach involves reacting the growing radicals reversibly with covalent species to produce persistent radicals. Another approach involves allowing the growing radicals to participate in a degenerative transfer reaction which regenerates the same type of radicals (see U.S. Pat. No. 4,581,429; Hawker, J. Am. Chem. Soc., 116:11185 (1994); and Georges et al., Macromolecules, 26:2987 (1993)).

Various types of initiators, methods of free radical generation, monomers, and free radical capping agents have been described (see, e.g., U.S. Pat. Nos. 5,677,388, 5,728,747, 5,708,102, 5,807,937, and 5,852,129.) A benzoyl peroxide-chromium initiator may also be used (see Lee et al., J. Chem. Soc. Trans. Faraday Soc. I, 74: 1726 (1978)). Additional types of initiators include α-haloester, alkoxyamine, and halobenzyl type initiators, all of which may be used in the present invention. See Husseman, Macromolecules, 32:1424-1431 (1999) and Hawker, Macromolecules, 30:373-82 (1997).

Examples of photoinitiators selected in various effective amounts, such as from about 1 to about 10 weight percent based on the total weight percent of reactants, include benzoins, disulfides, aralkyl ketones, oximinoketones, peroxyketones, acyl phosphine oxides, diamino ketones, such as Micher's ketones, 3-keto courmarins, and the like, and preferably 1-hydroxycyclohexyl phenyl ketone.

Examples of initiators include azo-type and nitroxide type. An example of a terminator is a stable free radical agent known as TEMPO (2,2,6,6-tetramethyl-1-piperidinyloxy) (see U.S. Pat. No. 5,728,747).

In preferred methods, a substrate (e.g., glass) is pre-silanized with an azo type initiator, such as 4,4′ azobis(pentanamide propyl triethoxysilane) (AIBN-APS) (I). On activation, such as by heating, N₂ is extruded, leaving two carbon radicals.

-alkyl-(Me)(CN)C≡N═N—C(Me)(CN)-alkyl-→2[-alkyl-(Me)(CN)C]+N₂

Azo type initiators are described for example in Pruker & Ruhe, Macromol., 31:592 601 (1998). AIBN-APS can be readily prepared (see U.S. Pat. No. 6,994,964; Chang & Frank, Langmuir, 12:5824 29 (1996); Chang and Frank, Langmuir, 14:326 334 (1998); Prucker and Ruhe, supra; Japanese Patent H1-234479; and Japanese Patent H3-99702).

Surface initiating sites include silane compounds, such as (X)ₐ(Y)_{b}Si—(Z)—Q, where b=3 minus a; X is Cl, OMe, or OEt; Y is C₁₋₄ alkyl; Z is C₂-C₂₀ alkyl, alkylaryl or polyoxyalkylidine; and Q is a radical forming precursor group. Q is H or alkyl when a diluent silane is used.

Other initiators include nitroxyl (Husseman et al., Macromol., 32:1421 31 (1999)), halo (Huang and Wirth, Anal. Chem., 69:4577 80 (1997)) and thiocarbamate (Kobayashi et al., J. Appl. Poly. Sci., 49:447 423 (1999)). Examples of initiator moieties include: —C(CN)(R¹)—N═N—C(CN)(R²)R³; —CR¹(R²)—S—C(═S)—N(R³)₂; —CR¹(R²)—ON(R³)R⁴; and —C(R¹)(R²)X; where R¹⁻⁴ are independently alkyl and X is I, Cl or Br.

Preferred initiators include an organic halide compound of the formula R—X, where R is any organic moiety and X is Cl, Br or I. Examples of organic halide compounds which include ethyl 2-bromoisobutyrate, ethyl 2-iodoisobutyrate, diethyl 2-bromo-2-methylmalonate, diethyl 2-iodo-2-methylmalonate, 2-chloropropionitrile, 2-bromopropionitrile, 2-iodopropionitrile, 2-bromo-2-methylpropionic acid, 2-bromoisobutyrophone, ethyl trichloroacetate, 2-bromoisobutyryl bromide, 2-chloroisobutyryl chloride, α-bromo-α-methyl-γ-butyrolactone, p-toluenesulfonyl chloride and its substituted derivatives, 1,3-benzenedisulfonyl chloride, carbon tetrachloride, carbon tetrabromide, chloroacetonitrile, iodoacetonitrile, tribromoethanol, tribromoacetyl chloride, trichloroacetyl chloride, tribromoacetyl bromide, chloroform, 1-phenyl ethylchloride, 1-phenyl ethylbromide, 2-chloropropionic acid, 2-bromoisobutyric acid, 4-vinyl benzene sulfonyl chloride, vinyl benzenechloride, 2-chloroisobutyrophenone, and 2-bromoisobutyrophenone.

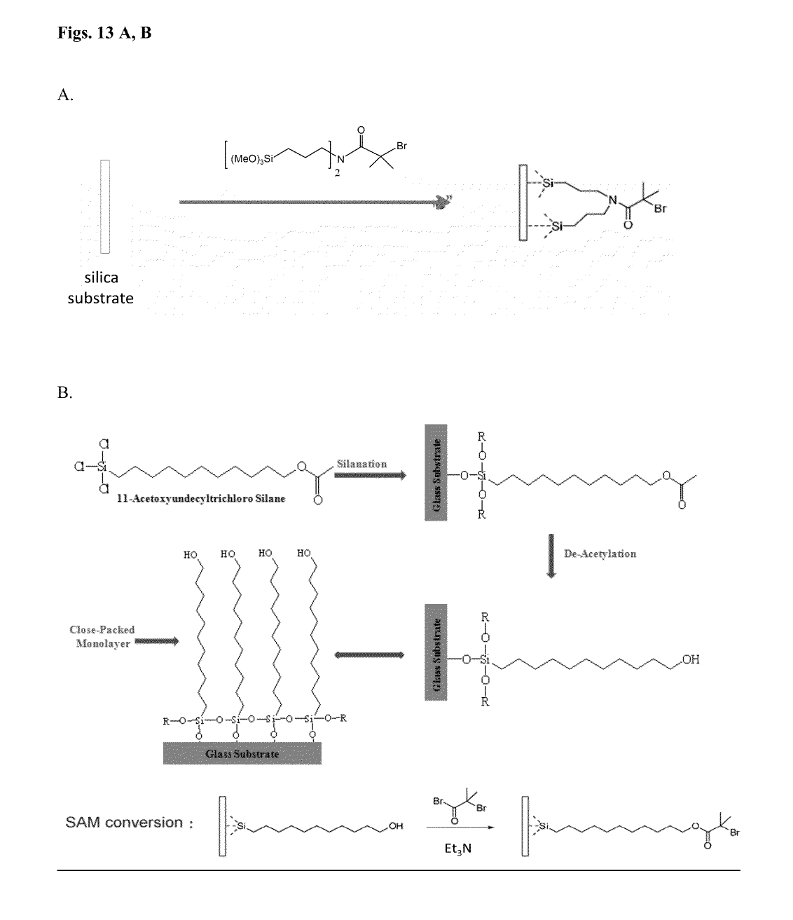

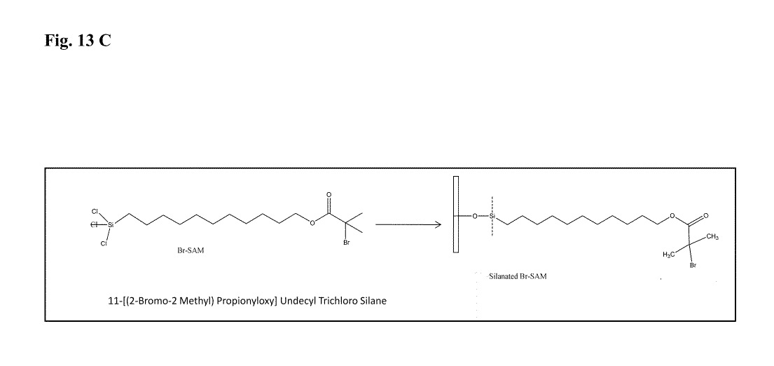

More preferably, the initiators are coupled to silane compounds such as a linker molecule. The silane compounds can have an organic halide as the function group (e.g., HEBS A-C below). The silane compounds can also have a functional group (e.g., a hydroxyl group) that is reactive with an organic halide compound (e.g., 2-bromoisobutyryl bromide) to have the organic halide compound attached to the linker molecules. Accordingly, the initiator can be linked to a silane compound before or after linking the silane compound to the surface of the substrate. Specific examples of silane compounds having an initiator site attached are illustrated in FIGS. 13A-C.

### 2. Monomers for Polymerization

The monomers are suitable to undergo free radical polymerization. A variety of monomers that provide the desired functional groups can be used. Some monomers that meet these criteria can be represented by the generic structures shown below:

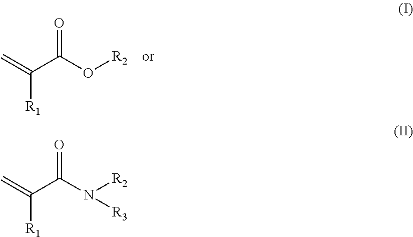

wherein R₁ is hydrogen or lower alkyl; R₂ and R₃ are independently hydrogen, or —Y—Z, wherein Y is lower alkyl, and Z is hydroxyl, amino, or C(O)—R, where R is hydrogen, lower alkoxy or aryloxy.

Preferred examples of monomers for polymerization include

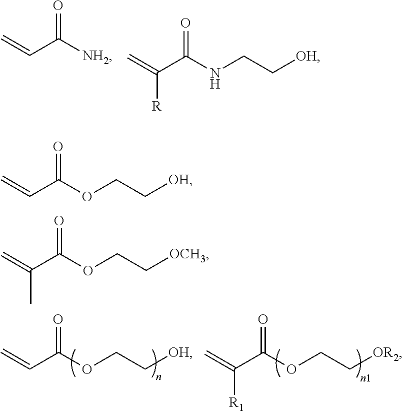

wherein R1 is hydrogen or lower alkyl; R2 is hydrogen or lower alkyl; n or n1=1-20.

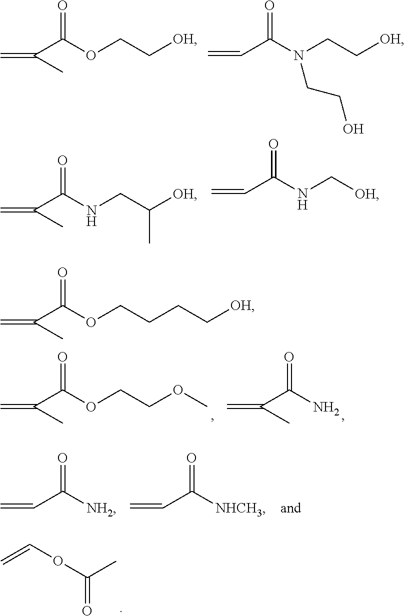

Additional examples include

### 3. Polymers

The present methods can be used to polymerize a mixture of two or more different polymerizable monomers to form copolymers therefrom. In particular, the present methods can be used to synthesize a copolymer silane compound having hydroxyl group (or other functional groups such as amine) distributed along the copolymer chain (e.g., starting from a silane compound having an initiator). The density of the functional group can be controlled by using a mixture of monomers, at least one of which does not contain the functional group. Preferably, the copolymer is synthesized using living polymerization methods from a mixture of a first group of monomers having the desired functional group (e.g., 0.1-100%, preferably 1-100%, most preferably 5-50%) and a second group of monomers that do not contain the functional group (e.g., 99.9-0%, preferably 99-0%, most preferably 50-95%).

Preferably, the desired functional group is a hydroxyl group. For example, a silane compound having hydroxyl group can be synthesized using: the first group selected from:

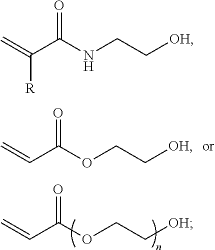

and the second group selected from:

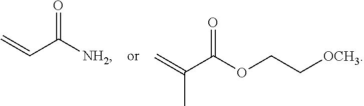

In some cases, the silane compounds are copolymers of

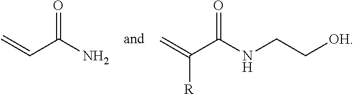

Preferably, the silane compounds are copolymers of

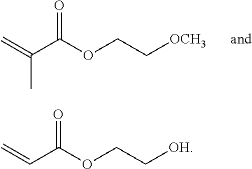

The first group of monomers can be acrylate compounds of formula (I), and the second group of monomers acrylamide compound of formula (II). Preferably, the first and second groups of monomers are both acrylate compounds of formula (I), or both acrylamide compounds of formula (II). Most preferably, both the first and the second groups of monomers are acrylate compounds of formula (I). Copolymer polyacrylates silane compounds are particularly advantageous because arrays synthesized using polyacrylates have significantly less latent hydroxyl site problems.

Preferred copolymer polyacrylates silane compounds include copolymers of

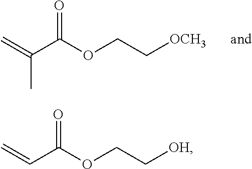

copolymers of

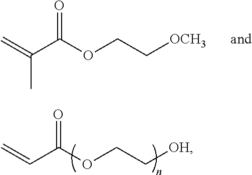

copolymers of

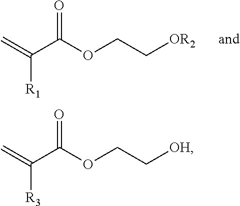

copolymers of copolymers of

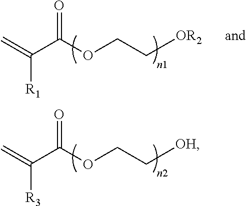

copolymers of

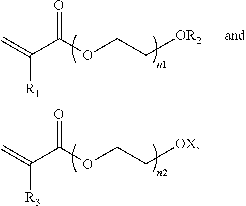

wherein R1 or R3 is hydrogen or lower alkyl; R2 is lower alkyl; n1 or n2=1-20; X is a protecting group. Most preferably, copolymer polyacrylates silane compounds is copolymers of

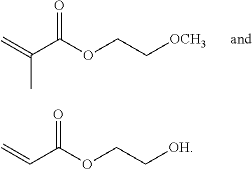

The copolymer can be synthesized on a self-assembled monolayer, e.g., using linker molecules having initiators attached. The self-assembled monolayer provides a stable uniform adhesion layer on the support as well as the initiation sites for initiating polymerization. The polymer brush synthesized on the self-assembled monolayer can be tailored to impart a wide range of chemical functionality and physical properties as desired for various assays and applications. Alternatively, the copolymer can be synthesized on surface layers based on other types of silanes (e.g., HEBS-type silane compounds).

The copolymer can be tailored to provide optimal properties such as suitable functional group spacing, improved wettability, and minimized non-specific binding of macromolecules. The final density of functional groups (e.g. hydroxyl) on the copolymer can be controlled by varying the relative amounts of non-functionalized and functionalized monomers. The thickness of the copolymer layer can be controlled by varying the polymer chain length and the number of surface initiators. Preferably, the copolymer has 10-50 monomers linked in a chain and/or a thickness 20-10,000 Å, preferably 50-5,000 Å, most preferably 100-1,000 Å.

The present methods can be used to synthesize linkers with including one or more copolymer segments. Each segment can be synthesized using various different monomers and with different ratios of these monomers. For example, the arrays can have a first segment and a second segment. The second segment can be synthesized after the first polyacrylamide segment. The arrays having multiple copolymer segments can be synthesized by contacting the active solid substrate with a different set of monomers at various points in time, either by transferring the substrate to a different reaction chamber containing a different monomer composition or ratio, or draining/replacing the reagents. Arrays having 2, 3, 4, or more segments can be prepared in this manner. In some arrays, the first segment is a polyacrylamide segment (e.g., for hydrophilicity and low background binding), and the second segment is a polyacrylate segment (e.g., to support probe synthesis). In some arrays, a second or subsequent segment is less densely packed than a first or previous segment to improve hybridization behavior and allow spacing for target binding. After synthesis of a previous segment, the yield of terminal initiator sites may decrease naturally due to normal chain terminating events occurring during polymerization. Further reduction can be effected by effected by actively capping or deactivating a fraction of the initiator sites.

Conditions for carrying out free radical polymerization are well-known and disclosed in U.S. Pat. No. 6,994,964 (the entire content of which is incorporated herein).

### V. Protection of Functional Group

Protection or inactivation of functional groups can occur at several stages of the present methods. During assembly of a monolayer, the tail group of a linker is preferably protected, inactivated or otherwise in precursor form. During polymer array synthesis, protective groups are usually used to protect a functional group on a linker to which a first monomer of a polymer is attached and subsequnt monomers. During the multi-layer synthesis described above, the functional group(s) on a previous layer are de-protected, activated or otherwise rendered functional before assembling the next monolayer layer.

A protecting or protective group blocks a reactive site on a molecule, but can be removed on exposure to an activator or a deprotecting agent. Activators include, for example, electromagnetic radiation, ion beams, electric fields, magnetic fields, electron beams, x-ray, and the like. A deprotecting agent is a chemical or agent which causes a protective group to be cleaved from a protected group. Deprotecting agents include, for example, an acid, a base or a free radical. A deprotecting agent can be an activatable deprotecting agent. An activatable deprotecting agent is a chemical or agent which is relatively inert with respect to a protective group, i.e., the activatable deprotecting agent will not cause cleavage of the protective group in any significant amount absent activation. An activatable deprotecting agent may be activated in a variety of ways depending on its chemical and physical properties. Some activatable deprotecting agents may be activated by exposure to some form of activator, e.g. electromagnetic radiation. Some activatable deprotecting agent will be activatable at only certain wave lengths of electromagnetic radiation and not at others. For example, certain activatable deprotecting reagents will be activated with visible or UV light. In some cases, a deprotecting agent can be a vapor phase deprotection agents, which can be introduced at low pressure, atmospheric pressure, among others.

A photolabile protecting group is a group that block a reactive site on a molecule while a chemical reaction is carried out at another reactive site, and which is removable by exposure to radiation such as light radiation (see, e.g., Pelliccioli & Wirz, Photochem. Photobiol. Sci. 2002, 1:441-458; Bochet, J. Chem. Soc., Perkin Trans. 12002, 125-142; Givens et al., In: Goeldner & Givens, (Eds.) Dynamic Studies in Biology: Phototriggers, Photoswitches, and Caged Compounds. J. Wiley & Sons, NY, 2005, p. 95-129; Pirrung, & Rana, in: Goeldner & Givens, (Eds.) Dynamic Studies in Biology: Phototriggers, Photoswitches, and Caged Compounds. J. Wiley & Sons, NY, 2005, p. 341-368; and references cited therein; which are hereby incorporated by reference herein in its entirety for all purpose). Specific examples of photolabile protecting groups for amines, thiols and hydroxyl groups include dimethoxybenzoin, 2-nitroveratryloxycarbonyl (NVOC); α-methyl-2-nitroveratryloxycarbonyl (MeNVOC); 2-nitropiperonyloxycarbonyl (NPOC); α-methyl-2-nitropiperonyloxycarbonyl (MeNPOC); 2-nitronaphth-1-ylmethyloxycarbonyl (NNPOC); α-methyl-2-nitronaphth-1-ylmethyloxycarbonyl; α-phenyl-2-nitronaphth-1-ylmethyloxycarbonyl; 2,6-dinitrobenzyloxycarbonyl (DNBOC), α-methyl-2,6-dinitrobenzyloxycarbonyl (MeDNBOC); α-phenyl-2-nitroveratryloxycarbonyl (MeNVOC); phenyl-2-nitropiperonyloxycarbonyl (MeNPOC); 2-(2-nitrophenyl)ethyloxycarbonyl (NPEOC), 2-methyl-2-(2-nitrophenyl)ethyloxycarbonyl (NPPOC); 1-pyrenylmethyloxycarbonyl (PYMOC), 9-anthracenylmethyloxycarbonyl (ANMOC); 7-methoxycoumarin-4-ylmethyloxycarbonyl (MCMOC); 6,7-dimethoxycoumarin-4-ylmethyloxycarbonyl (DMCMOC); 7-(N,N-diethylamino)coumarin-4-ylmethyloxycarbonyl (DEACMOC); 3′ methoxybenzoinyloxycarbonyl (MBOC), 3′,5′-dimethoxybenzoinyloxycarbonyl (DMBOC), 7-nitroindolinyloxycarbonyl (NIOC), 5-bromo-7-nitroindolinyloxycarbonyl (BNIOC), 5,7-dinitroindolinyloxycarbonyl (DNIOC), 2-anthraquinonylmethyloxycarbonyl (AQMOC), α,α-dimethyl-3,5-dimethoxybenzyloxycarbonyl. The non-carbonate, benzylic forms of any of the foregoing, e.g., nitroveratryl (NV), α-methyl nitroveratryl (MeNV), etc., can be used for the protection of carboxylic acids as well as for amines, thiols and hydroxyl groups.

A chemically-removable protecting group is a group that blocks a reactive site in a molecule while a chemical reaction is carried out at another reactive site, and which is removable by exposure to a chemical agent, that is by means other than exposure to radiation. For example, one type of chemically-removable protecting group is removable by exposure to a base (i.e., “base-removable protecting groups”). Examples of specific base-removable protecting groups include but are not limited to fluorenylmethyloxycarbonyl (FMOC), 2-cyanoethyl (CE), N-trifluoroacetylaminoethyl (TF), 2-(4-nitrophenyl)ethyl (NPE), and 2-(4-nitrophenyl)ethyloxycarbonyl (NPEOC). Exocyclic amine groups on nucleotides; in particular on phosphoramidites, are preferably protected by dimethylformamidine on the adenosine and guanosine bases, and isobutyryl on the cytidine bases, both of which are base labile protecting groups. Another type of chemically removable protecting groups are removable by exposure to a nucleophile (i.e., “nucleophile-removable protecting groups”). Specific examples of nucleophile-removable protecting groups including but are not limited to levulinyl (Lev) and aryloxycarbonyl (AOC). Other chemically-removable protecting groups are removable by exposure to an acid (i.e., “acid-removable protecting groups”). Specific acid-removable protecting groups include but are not limited to triphenylmethyl (Tr or trityl), 4-methoxytriphenylmethyl (MMT or monomethoxytrityl), 4,4′-dimethoxytriphenylmethyl (DMT or dimethoxytrityl), tert-butoxycarbonyl (tBOC), α,α-dimethyl-3,5-dimethyoxybenzyloxycarbonyl (DDz), 2-(trimethylsilyl)ethyl (TMSE), benzyloxycarbonyl (CBZ), dimethoxytrityl (DMT), and 2-(trimethylsilyl)ethyloxycarbonyl (TMSEOC). Another type of chemically-removable protecting group is removable by exposure to a reductant (i.e., “reductant-removable protecting group”). Specific examples of reductant-removable protecting groups include 2-anthraquinonylmethyloxycarbonyl (AQMOC) and 2,2,2-trichloroethyloxycarbonyl (TROC). Additional examples of chemically-removable protecting groups include allyl (All) and allyloxycarbonyl (AIIOC) protecting groups.

Typical examples of carboxyl-protecting groups include tert-butyl, 2,2,2-trichloroethyl, acetoxymethyl, propionyloxymethyl, pivaloyloxymethyl, 1-acetoxyethyl, 1-propionyloxyethyl, 1-(ethoxycarbonyloxy)ethyl, benzyl, 4-methoxybenzyl, 3,4-dimethoxybenzyl, 4-nitrobenzyl, benzhydryl, bis(4-methoxyphenyl)methyl, 5-methyl-2-oxo-1,3-dioxolen-4-yl-methyl, trimethylsilyl, tert-butyldimethylsilyl, and preferably benzhydryl, tert-butyl and 4-methoxybenzyl.

Examples of amino-protecting groups include trityl, formyl, chloroacetyl, trifluoroacetyl, tert-butoxycarbonyl, trimethylsilyl, tert-butyldimethylsilyl.

Examples of hydroxyl-protecting groups include 2-methoxyethoxymethyl, 4-methoxybenzyl, dimethoxymethyl, methylthiomethyl, tetrahydropyranyl, tert-butyl, benzyl, 4-nitrobenzyl, trityl, acetyl, chloroacetyl, 2,2,2-trichloroethoxycarbonyl, benzyloxycarbonyl, trimethylsilyl, tert-butyldimethylsilyl.

Protecting groups such as 4-nitrobenzyloxy-carbonyl can be removed by catalytic reduction, and the protecting group such as 2,2,2-trichloroethoxy carbonyl can be removed by reduction with zinc and an acid such as acetic acid, and protecting groups such as chloroacetyl can be removed by treatment with thiourea. And also deprotection of trimethylsilyl group may only be done by water.

### VI. Extension Linker Molecules

An extension linker molecule can be used to extend the length of a functional SAM linker or an in situ synthesized linker. An extension linker provides added flexibility and accessibility for synthesis and use of polymer arrays. Such an extension linker molecule can be coupled to the SAM or in situ synthesized linker molecule via convention chemistry, e.g., click-chemistry or phosphoramidite chemistry. Accordingly, the extension linker molecule includes a coupling group (e.g., a phosphoramidite group) that can be coupled to the tail group (e.g., a hydroxyl group) located on the SAM or in situ synthesized linker molecule. The functional group on the extension linker that couples to the tail group of a SAM linker is sometimes referred to as a head group.

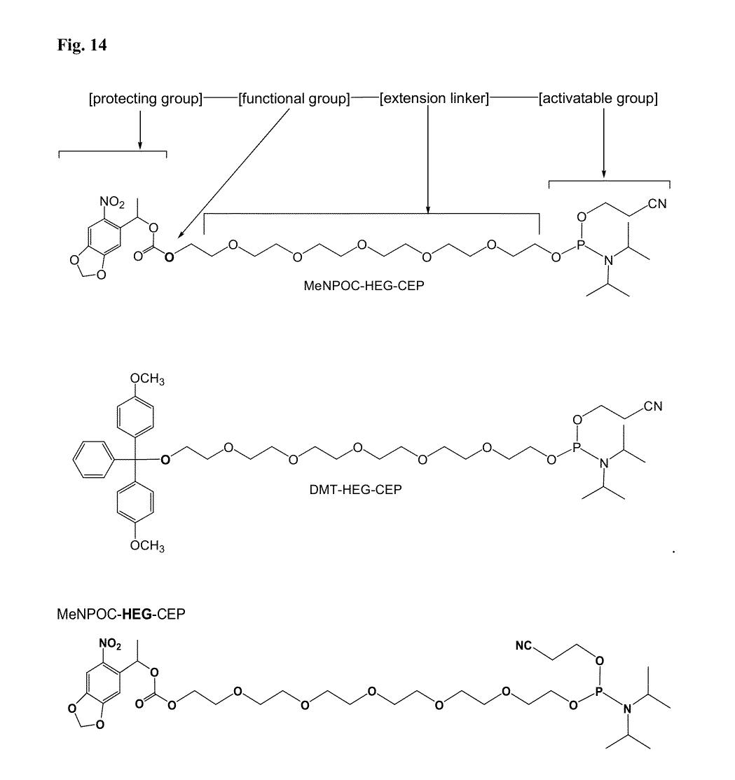

The extension linker molecule also includes a functional group that is capable of reacting to permit the formation of a covalent bond between the extension linker molecule and other substances, such as a polymer (e.g., nucleic acids). Preferably, the functional group (e.g., a hydroxyl group) is a group that is capable of reacting with activated nucleotides to permit nucleic acid synthesis. This functional group is sometimes referred to as a tail group of the extension linker, and is typically in a chemically protected form to avoid reaction with the head group, or other undesirable side reactions. After covalently attaching the extension linker to the surface functional groups, the protecting group would then be removed to allow subsequent chemical reactions with the functional group (e.g., hydroxyl group) of the extension linker. Examples of extension linker molecules include

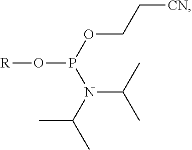

wherein R is preferably (protecting group)-(OCH₂CH₂)ₙ—); more preferably (protecting group)-(OCH₂CH₂)₂₋₂₀— or (protecting group)-(OCH₂CH₂)₄₋₈—; and most preferably (protecting group)-(OCH₂CH₂)₆—. Exemplary extension linker molecules are shown in FIG. 14.

Preferably the extension linker is a polymer of ethylene oxide. Examples of polymers of ethylene oxide include: polyethylene glycol (PEG), such as short to very long PEG; hexaethylene glycol (HEG); branched PEG; amino-PEG-acids; PEG-amines; PEG-hydrazines; PEG-guanidines; PEG-azides; biotin-PEG; PEG-thiols; and PEG-maleinimides. Examples of PEG includes: PEG-1000, PEG-2000, PEG-12-OMe, PEG-8-OH, PEG-12-COOH, and PEG-12—NH₂. In some cases, the extension linker can include a polyethylene oxide (PEO) polymer chain comprised of linked ethylene oxide (EO) units or a polyethylene glycol (PEG) polymer chain. The PEO polymer chain can optionally include one or more hexapolyethylene oxide (HEO) units. Optionally, the HEO units can be linked by, e.g., bisurethane tolyl linkages. Optionally, the extension linker includes 1, 2, 3, 4, or more HEO units. Examples of HEO-comprising linkers can be found, for example, in U.S. Pat. No. 5,807,682 to Grossman et al. A wide variety of PEG and modified PEG derivatives with a variety of bifunctional and heterobifunctional end crosslinkers can be used.

Other polymers that may be employed as extension linkers include poly-glycine, poly-proline, poly-hydroxyproline, poly-cysteine, poly-sehne, poly-aspartic acid, poly-glutamic acid, polyglycols, polypyridines, polyisocyanides, polyisocyanates, poly(triarylmethyl)methacrylates, polyaldehydes, polypyrrolinones, polyureas, polyglycol phosphodiesters, polyacrylates, polymethacrylates, polyacrylamides, polyvinyl esters, polystyrenes, polyamides, polyurethanes, polycarbonates, polybutyrates, polybutadienes, polybutyrolactones, polypyrrolidinones, polyvinylphosphonates, polyacetamides, polysaccharides, polyhyaluranates, polyamides, polyimides, polyesters, polyethylenes, polypropylenes, polystyrenes, polycarbonates, polyterephthalates, polysilanes, polyurethanes, polyethers, polyamino acids, polyglycines, polyprolines, polylysine, N-substituted polylysine, polypeptides, side-chain N-substituted peptides, poly-N-substituted glycine, peptoids, side-chain carboxyl-substituted peptides, homopeptides, polycytidylic acid, polyadenylic acid, polyuridylic acid, polythymidine, polyphosphate, polyethylene glycol-phosphodiesters, peptide polynucleotide analogues, threosyl-polynucleotide analogues, glycol-polynucleotide analogues, morpholino-polynucleotide analogues, locked nucleotide oligomer analogues, polypeptide analogues, branched polymers, comb polymers, star polymers, dendritic polymers, random, gradient and block copolymers, anionic polymers, cationic polymers, polymers forming stem-loops, rigid segments and flexible segments.

Extension linkers can be used in combination, i.e., an extension linker molecule is coupled to another extension linker molecule for providing sites for polymer attachment or synthesis.

However, an extension linker need not be used. That is, the polymers can be linked to a synthesized monomer directly on the deprotected tail groups of SAM or in situ synthesized linkers.

In a further variation, SAM's can be formed as previously described with a SAM linker to which an extension linker is already attached. A preferred formula for such a combination linker is

X₃Si—(CH₂)ₘ—(CF₂)ₙ—(CH₂)ₚ—(OCH₂CH₂)_{q}—Y,

X═Cl; OR, NR₂ (where R=methyl or ethyl); m=0-30; n=0-18; p=0-30; (m+n+p=6-30; preferably 8-18; more preferably 10-16); q=0-20 (preferably 0-8; more preferably 3-6).
Y=hydroxyl, thiol, amine, hydrazine, oxylamine, sulfonate, sulfate, carboxylate, thiocarboxylate, aldehyde, carboxaldehyde, and protected forms thereof; halogen, azide, alkyl- or aryl-disulfide, isocyanate, isothiocyanate, alkene, vinyl, alkyne, oxyalkyl, AcO, oxyaryl. Examples of functional SAM-forming silane with polyethylene glycol tail include Cl₃Si(CH₂)₂₂(OCH₂CH₂)₂—OCH₂CO₂CH₃ and Cl₃Si(CH₂)₂₂OCH₂CH₂—OAc (see U.S. Pat. No. 6,979,540).

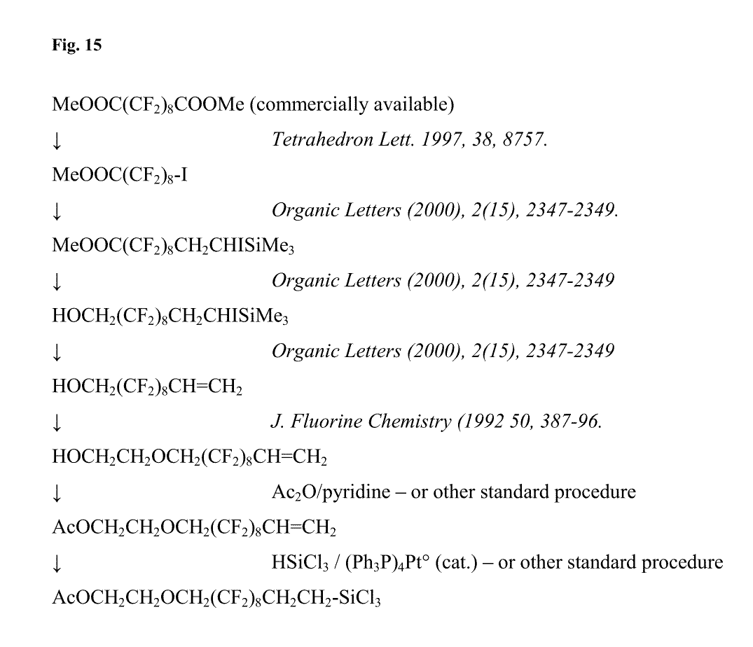

Such a linker can be synthesized with a fluorocarbon chain by the synthetic scheme shown in FIG. 15. An analogous synthetic scheme can be used to synthesize a fluorinated SAM linker without the PEG moiety.

Some other combined SAM linkers conform to the following formula: X₃Si—(C R^{x})ₘ—(OCH₂CH₂)_{q}—Y, wherein R^{x} is H or F, and m is 6-30; preferably 8-18; more preferably 10-16, and other symbols are as immediately above. Preferably the two Rx's on the same carbon are both H or both F.

### VII. Capping

Any unreacted deprotected functional groups (e.g., those of linker molecules or extension linker molecules) may be capped at any point during a synthesis reaction to avoid or to prevent further reaction with such molecule. Capping groups cap deprotected functional groups by, for example, reacting with the unreacted amino functions to form amides.

Capping agents can be used to modulate the functional site density of a monolayer or multi-layer. For example, density of functional groups on the surface of a monolayer or multi-layer formed using linker molecules having a functional group can be controllably varied by using a mixture having different ratios of the extension linker molecule and the capping agent. Depending on the applications for the monolayer array, a 100:1, 50:1, 20:1, 10:1, 1:1, 1:10, 1:20, 1:50, and 1:100 molar ratio of an extension linker molecule to a capping agent can be used. Preferably, a 1:10 to 1:50 molar ratio (e.g., 1:10, 1:25, 1:50 or 1:25 to 1:50) of an extension linker molecule to a capping agent is used. Preferably, a mixture of phosphoramidite-PEG and phosphoramidite-unicap (diethyleneglycol ethyl ether (2-cyanoethyl)-(N,N-diisopropyl)-phosphoramidite, available from Glen Research, Stirling, Va.) is used. Optionally, prior to the modulation of functional site density using a mixture of an extension linker molecule and a capping agent, the monolayer or multi-layer can be first extended using an extension linker molecule (e.g., PEG) to add additional flexibility and hydrophilicity to the to the substrate, if desired.

Exemplary capping agents include acetic anhydride, n-acetylimidizole, isopropenyl formate, and preferably (diethyleneglycol ethyl ether (2-cyanoethyl)-(N,N-diisopropyl)-phosphoramidite); acetic anhydride and n-acetylimidizole. More preferably, capping agents include

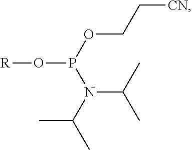

wherein R is alkyl such as methyl; ethyl, allyl; t-butyl; benzyl; 2-cyanoethyl; 2-methoxyethyl; 2-(alkylsulfonyl)ethyl; 2-alkoxyethyl; 2-(2-alkoxy-ethoxy)-ethyl; alkoxy-poly(ethoxy)ethyl alkyl-(OCH₂CH₂)ₙ—); preferably R is methyl-(OCH₂CH₂)₀₋₁₀— or ethyl-(OCH₂CH₂)₀₋₁₀—; more preferably R is methyl-(OCH₂CH₂)₁₋₅-, ethyl-(OCH₂CH₂)₁₋₅—, methyl-(OCH₂CH₂)₂₋₃—, or ethyl-(OCH₂CH₂)₂₋₃—; and most preferably CH₃(OCH₂CH₂)₃—.

### VIII. Contact Angle as a Measure of Hydrophobicity

Varying the number of monolayers, the ratio of functional to nonfunctional linker molecules in a monolayer or the ratio of extension linker molecules to capping agents or the ratio of linker molecules to non-functional linking molecules, changes the hydrophobicity of the array surface. Changes in hydrophobicity can be monitored from the contact angle.

One measure of hydrophobicity of a material is a contact angle between a surface of the material and a line tangent to a drop of water at a point of contact with the surface. (see e.g. Churaev, N. V., & Sobolev, V. D., Advances in Colloid and Interface Science (2007) 134-135, 15-23; Gao, L., & McCarthy, T. J., Langmuir (2007) 23, 18, 9125-9127). A surface with a higher contact angle (with respect to water) can therefore generally be taken to be of higher hydrophobicity than a surface with a lower contact angle.

A contact angle θ is given by the angle between the interface of the droplet and the horizontal surface. The most commonly used technique of determining the contact angle is the static or sessile drop method. The advancing contact angle is measured when a plateau in the contact angle is reached upon a successive addition of liquid droplets. The receding contact angle is measured when the contact point of a liquid droplet on a surface begins to change upon retracting the liquid of the droplet. Other means of determining the contact angle include the Wilhemly Plate method, the Captive Air Bubble method, the Capillary Rise method, and the Tilted-drop measurement. Interference microscopy or confocal microscopy can be used, in particular with fluorescent droplets, or a combination of both methods. A respective combination technique has for example been described by Sundberg et al. (Journal of Colloid and Interface Science, 313, 454-460, 2007). Two further means of determining surface energy (what is surface energy) are atomic force microscopy and sum frequency generation, a vibrational spectroscopy method (see for example Opdahl et al., The Chemical Record (2001) 1, 101-122).

A contact angle θ of zero results in wetting. A contact angle θ between about 0° and about 90° results typically in spreading of the liquid droplet, in particular at values in the range below about 45°. Contact angles θ greater than about 90° indicate the liquid tends to bead or shrink away from the solid surface.

After a SAM array has been formed but before a hydrophilic extension linker has been added, a high contact angle for water is preferred because it indicates at dense, uniform, hydrophobic SAM to provide a stable base layer. Hydrophobicity confers stability by water-repellence. Water penetrating the monolayer and disrupting the bonds to the silica substrate is the main cause of degradation of the monolayer. After formation of the SAM but before adding the extension linker, the contact angle is preferably >40°, >60°, >80°, or >120°. Thus, the contact angle for water can be, e.g., 40-120, 50-110 or 60-90 degrees.

After an extension linker (e.g., PEG) or an ATRP acrylate polymer brush layer (or ATRP multilayers)), the contact angle for water is reduced preferably to <70°, <50°, <20°, or 0°. Low angles are indicative of a hydrophilic surface region, which is a favorable environment for biomolecular interactions of finished arrays (e.g., hybridization, antibody binding).

### IX. Array Synthesis

Molecules of SAM or in situ synthesized linkers provide sites of attachment for polymer arrays. To distinguish the polymers in arrays, which may be nucleic acids, peptides, polysaccharides, among others, from polymers synthesized in situ as linkers, the polymers in an array are sometimes referred to as array polymers. Attachment can be direct as when an array polymer is linked directly to a tail group of a SAM linker or to a functional group of a functional monomer in a linker synthesized in situ. Attachment can be indirect as when an array polymer is linked to the tail group of SAM linker or to a functional group of a functional monomer in a linker synthesized in situ via an extension linker. If an extension linker is used, array polymers are linked to a functional group of the extension linker. Usually polymers are linked so that the first monomer incorporated into an array polymer is linked to the functional group of an extension linker or to the tail group of a SAM linker or functional group of a monomer of a linker synthesized in situ. The bond formed between an array polymer and a linker can be covalent or non-covalent. Covalent bonding is preferred for monomer-by-monomer synthesis. Preferably, array polymer molecules attach to linker molecules by a single bond joining defined positions of individual polymer and linker molecules such that polymers and linker molecules are uniformly bonded to one another at defined locations on the respective molecules.

Methods and techniques applicable to polymer (including nucleic acid and protein) array synthesis have been described in, WO 00/58516, U.S. Pat. Nos. 5,143,854, 5,242,974, 5,252,743, 5,324,633, 5,384,261, 5,405,783, 5,424,186, 5,451,683, 5,482,867, 5,491,074, 5,527,681, 5,550,215, 5,571,639, 5,578,832, 5,593,839, 5,599,695, 5,624,711, 5,631,734, 5,795,716, 5,831,070, 5,837,832, 5,856,101, 5,858,659, 5,936,324, 5,968,740, 5,974,164, 5,981,185, 5,981,956, 6,025,601, 6,033,860, 6,040,193, 6,090,555, 6,136,269, 6,269,846 and 6,428,752, and in WO 99/36760 and WO 01/58593, U.S. Pat. Nos. 5,412,087, 6,147,205, 6,262,216, 6,310,189, 5,889,165, and 5,959,098. Nucleic acid probe arrays are described in many of the above patents, but the same techniques are applied to polypeptide arrays and other polymers.

Polymer arrays can be synthesized in a monomer-by-monomer fashion (i.e., polymers are formed by successive coupling of component monomers) or by attachment of preformed polymers. The present linkers are particularly useful for monomer-by-monomer synthesis because they reduce occurrence of latent functional groups in the linkers resulting in unintended new polymers being started as coupling of the intended polymers progresses. In monomer-by-monomer synthesis the linker (whether an extension linker, SAM linker or in situ synthesized linker) to which the first monomer attaches is initially protected and then deprotected before coupling occurs. The first monomer and successive monomers have at least two functional groups, one to couple to the nascent polymer chain, the other to couple to the next monomer to be added to the chain. The latter function group is typically protected during the coupling step so that polymers are elongated one monomer at a time. The protective group on a monomer is removed after its incorporation to allow coupling to the next monomer.

Monomers can be targeted to specific features of an array by various methods. In one set of methods, arrays are synthesized by a process involving alternating steps of selective activation and coupling. The selective activation removes protecting groups for functional groups either on a linker or on monomers coupled in previous steps generating a pattern of activated regions and inactivated regions on the surface. In the coupling step, a protected monomer is contacted with the support and couples to the functional groups in the activated regions but not at the inactivated regions. By repeating the selective activating and coupling steps different polymers are formed at defined locations on the surface, the sequence and location of the different polymers being defined by the patterns of activated and inactivated regions formed during each activating step and the monomer coupled in each coupling step. Selective deprotection can be achieved with light and photoremovable protective groups or other forms of radiation and corresponding removable protective groups. Selective deprotection can also be achieved using light to remove a photoresist covering a surface of a support from selected regions and subsequently removing protective groups in those regions by chemical treatment, for example use of acid. After removing protective groups from selected regions, the entire surface of a support can be contacted with a protected monomer, which will attach only at the deprotected regions (see, e.g., US20050244755).

Alternatively, monomers can be targeted to selected features by mechanical means including the use of spotters, flow channels, ink jet printers and the like (see U.S. Pat. No. 5,677,195 and U.S. Pat. No. 5,384,261). In such methods, the linker to which the first monomer is attached and the monomers are typically protected as in selective activation methods. However, selective targeting is achieved by the selective delivery of monomers. In such methods, an entire surface can be deprotected at the same time.

In a further approach, preformed polymers are attached to linker molecules. In this case, reaction typically occurs between a designated functional group on the preformed polymers, usually on a terminal monomer, and a functional group on the linker molecules. The functional group on the linker molecules can be protected before attachment of the preformed polymer. Targeting of polymers to selected features of an array is typically achieved by mechanical means, particularly spotting. Robotic spotting systems for automated delivery of small quantities of reformed polymers to selected features are available. Spotting methods are described by e.g., Auburn et al., Trends Biotechnol. 2005 23(7):374-9; Mandruzzato, Adv. Exp. Med. Biol. 2007; 593:12-8.

Polymers can also be synthesized on beads as described in the U.S. Pat. Nos. 5,384,261, 7,745,091, 7,745,092 and U.S. Patent Application Publication Nos. US20100290018, US20100227279, US20100227770, US20100297336, and US20100297448 (incorporated herein by reference in their entirety for all purposes). For the synthesis of molecules such as polynucleotides on beads, a large plurality of beads are suspended in a suitable carrier (such as water or an appropriate assay buffer) in a container. The beads are provided with optional spacer molecules having an active site. The active site is protected by an optional protecting group.

Examples of polymer arrays that can be synthesized include nucleic acids, both linear and cyclic, peptides, polysaccharides, phospholipids, heteromacromolecules in which a known drug is covalently bound to any of the above, polyurethanes, polyesters, polycarbonates, polyureas, polyamides, polyethyleneimines, polyarylene sulfides, polysiloxanes, polyimides, and polyacetates. The polymers occupying different features of an array typically differ from one another, although some redundancy in which the same polymer occupies multiple features can be useful as a control. For example, in a nucleic acid array, the nucleic acid molecules within the same feature are typically the same, whereas nucleic acid molecules occupying different features are mostly different from one another.

A preferred method of synthesis is VLSIPS™ (see Fodor et al., Nature 364, 555-556; McGall et al., U.S. Pat. No. 5,143,854; EP 476,014), which entails the use of light or other radiation to direct the synthesis of polymers. Algorithms for design of masks to reduce the number of synthesis cycles are described by Hubbel et al., U.S. Pat. No. 5,571,639 and U.S. Pat. No. 5,593,839. Arrays can also be synthesized in a combinatorial fashion by delivering monomers to cells of a support by mechanically constrained flowpaths. See Winkler et al., EP624,059. Arrays can also be synthesized by spotting monomers reagents on to a support using an ink jet printer. See id.; EP 728,520.

Performing both peptide and nucleic acid synthesis by photolithographic methods requires closely analogous modifications of conventional solid phase chemical synthesis methods. In each case, the protective group that protects the monomer is changed from a protective group that is suitable for chemical removal to protective group that is photosensitive and can be removed by irradiation. Irradiation is directed e.g., through a mask to a substrate to remove a photosensitive protecting group from known locations on the substrate. The substrate is then exposed to a protected monomer that attaches at the deprotected locations. Then irradiation is again directed through the mask to the substrate exposing known locations (the same or different than before). Then a further protected monomer is supplied, and so forth.

Cho et al., Science 261, 1303-5 (1993) describes the use of a photodeprotection strategy to synthesize an array of oligocarbamates substituted with a variety of side chains. The polymers were synthesized from nitrophenyl carbonate monomers bearing a photosensitive protecting group on a terminal amino moiety. Synthesis is proceeded by photodeprotection of the amino group on an immobilized growing chain allowing coupling of an incoming protected oligocarbamate.

For synthesis of polyureas, a tethered amino group having a radiation-sensitive protecting group is deprotected and treated with a monomer having a first functional group that is an isocyanate and a second functional group that is an amine, protected with a radiation sensitive protecting group. The reaction conditions are adjusted to allow the tethered amine to react with the isocyanate and couple the monomer to the support by forming a urea linkage. The tethered monomer can then be deprotected to liberate or make available the amine functional group that is then free to react with another monomer having an isocyanate and a protected amine. In such a stepwise fashion, a polyurea can be constructed.

Polyamides can be prepared in the same manner as is used for peptide construction. In particular, each monomer has a first carboxylic acid functional group and a second amine, protected with a radiation sensitive protecting group.

The number of different polymers, such as nucleic acids, in an array can be at least 10, 50, 60, 100, 10³, 10⁴, 10⁵, 10⁶, 10⁷, or 10⁸ on a contiguous substrate surface. An array can be subdivided into discrete regions also known as features or cells. Within a cell the polymer molecules are generally of the same type (with the possible exception of a small amount of bleed over from cells and presence of incomplete polymer intermediates of polymer synthesis). It is generally known or determinable, which polymers occupy which regions in an array. The size of individual regions can range from about 1 cm² to 10⁻¹⁰ cm². In some arrays, the individual regions have areas of less than 10⁻¹, 10⁻², 10⁻³, 10⁻⁴, 10⁻⁵, 10⁻⁶, 10⁻⁷, 10⁻⁸, 10⁻⁹, or 10⁻¹⁰ cm². The individual regions can be contiguous with one another as can result from VLSIPS methods, or noncontiguous as generally results from spotting methods. The density of regions containing different polymers can thus be greater than 103, 104, 105 or 106 polymers per cm². The polymers can incorporate any number of monomers. Polymers, containing 5-100, 10-50, 10-35 or 15-30 monomers are preferred. Thus for a nucleic acid array, oligonucleotides of 5-100, 10-50, 10-35 or 15-30 nucleotides are preferred.

### XI. Sample Processing

Samples can be processed by various methods before analysis. Prior to, or concurrent with, analysis a nucleic acid sample may be amplified by a variety of mechanisms, some of which may employ PCR. (See, for example, PCR Technology: Principles and Applications for DNA Amplification, Ed. H. A. Erlich, Freeman Press, NY, N.Y., 1992; PCR Protocols: A Guide to Methods and Applications, Eds. Innis, et al., Academic Press, San Diego, Calif., 1990; Mattila et al., Nucleic Acids Res., 19:4967, 1991; Eckert et al., PCR Methods and Applications, 1:17, 1991; PCR, Eds. McPherson et al., IRL Press, Oxford, 1991; and U.S. Pat. Nos. 4,683,202, 4,683,195, 4,800,159 4,965,188, and 5,333,675, each of which is incorporated herein by reference in their entireties for all purposes. The sample may also be amplified on the polymer array. (See, for example, U.S. Pat. No. 6,300,070 and U.S. patent application Ser. No. 09/513,300 (abandoned), all of which are incorporated herein by reference).

Other suitable amplification methods include the ligase chain reaction (LCR) (see, for example, Wu and Wallace, Genomics, 4:560 (1989), Landegren et al., Science, 241:1077 (1988) and Barringer et al., Gene, 89:117 (1990)), transcription amplification (Kwoh et al., Proc. Natl. Acad. Sci. USA, 86:1173 (1989) and WO 88/40315), self-sustained sequence replication (Guatelli et al., Proc. Nat. Acad. Sci. USA, 87:1874 (1990) and WO 90/06995), selective amplification of target polynucleotide sequences (U.S. Pat. No. 6,410,276), consensus sequence primed polymerase chain reaction (CP-PCR) (U.S. Pat. No. 4,437,975), arbitrarily primed polymerase chain reaction (AP-PCR) (U.S. Pat. Nos. 5,413,909 and 5,861,245) and nucleic acid based sequence amplification (NABSA). (See also, U.S. Pat. Nos. 5,409,818, 5,554,517, and 6,063,603, each of which is incorporated herein by reference). Other amplification methods that may be used are described in, for instance, U.S. Pat. Nos. 6,582,938, 5,242,794, 5,494,810, and 4,988,617, each of which is incorporated herein by reference.

Additional methods of sample preparation and techniques for reducing the complexity of a nucleic sample are described in Dong et al., Genome Research, 11:1418 (2001), U.S. Pat. Nos. 6,361,947, 6,391,592, 6,632,611, 6,872,529 and 6,958,225, and in U.S. patent application Ser. No. 09/916,135 (abandoned).

Hybridization assay procedures and conditions vary depending on the application and are selected in accordance with known general binding methods, including those referred to in Maniatis et al., Molecular Cloning: A Laboratory Manual, 2^{nd} Ed., Cold Spring Harbor, N.Y., (1989); Berger and Kimmel, Methods in Enzymology, Guide to Molecular Cloning Techniques, Vol. 152, Academic Press, Inc., San Diego, Calif. (1987); Young and Davism, Proc. Nat'l. Acad. Sci., 80:1194 (1983). Methods and apparatus for performing repeated and controlled hybridization reactions have been described in, for example, U.S. Pat. Nos. 5,871,928, 5,874,219, 6,045,996, 6,386,749, and 6,391,623 each of which are incorporated herein by reference.

Hybridization refers to the process in which two single-stranded polynucleotides bind non-covalently to form a stable double-stranded polynucleotide; triple-stranded hybridization is also theoretically possible. The resulting (usually) double-stranded polynucleotide is a hybrid. The proportion of the population of polynucleotides that forms stable hybrids is referred to as the degree of hybridization. Hybridizations are usually performed under stringent conditions, for example, at a salt concentration of no more than about 1M and a temperature of at least 25° C. For example, conditions of 5×SSPE (750 mM NaCl, 50 mM sodium phosphate, 5 mM EDTA, pH 7.4) and a temperature of 25-30° C. are suitable for allele-specific probe hybridizations or conditions of 100 mM MES, 1M [Na⁺], 20 mM EDTA, 0.01% Tween-20 and a temperature of 30-50° C., or at about 45-50° C. Hybridizations may be performed in the presence of agents such as herring sperm DNA at about 0.1 mg/ml, acetylated BSA at about 0.5 mg/ml. As other factors may affect the stringency of hybridization, including base composition and length of the complementary strands, presence of organic solvents and extent of base mismatching, the combination of parameters is more important than the absolute measure of any one alone. Hybridization conditions suitable for microarrays are described in the Gene Expression Technical Manual, 2004 and the GeneChip® Mapping Assay Manual, 2004.

Hybridization signals can be detected by conventional methods, such as described by, e.g., U.S. Pat. Nos. 5,143,854, 5,578,832, 5,631,734, 5,834,758, 5,936,324, 5,981,956, 6,025,601, 6,141,096, 6,185,030, 6,201,639, 6,218,803, and 6,225,625, US 2004/0012676 and WO 99/47964, each of which is hereby incorporated by reference in its entirety for all purposes).

### XII. Uses of Arrays

Arrays are typically used to analyze a target molecule. Typically, the target molecule is contacted with the array and binding of different polymers occupying different features of the array to the target are detected. The target molecule can bear a label (e.g., fluorescent or radioactive) that can be detected directly. Alternatively, the target can bear a label detectable indirectly. For example, the target can be labeled with biotin and the biotin detected by fluorescently labeled streptavin. The signal can be further amplified by contacting with an antibody to streptavin and a biotinylated anti-idiotypic antibody, which binds further fluorescently labeled streptavidin. Signal amplification can also be achieved by enzymatic amplification (see, e.g., tyramide signal amplification, Karsten, et al. Nucl Acids Res 2002, 30:e4; rolling circle amplification: Schweitzer, et al. Nat Biotechnol 2002, 359-65; proximity ligation assay: Jarvius, et al. Nat. Methods 2006, 3:725-7) or non-enzymatic amplification (see, for instance, QuantiGene® technology, Affymetrix, Inc., Santa Clara, Calif., U.S. Provisional Patent Application Ser. Nos. 61/360,887, 61/361,007 and 61/360,912, U.S. Pat. Nos. 7,803,541, 7,709,198, 7,033,758, 6,232,462, 6,235,465, 6,300,056, 7,803,541 and Published US Patent Application No. 2006-0263769, all of which are incorporated herein by reference in their entireties for all purposes). In a further approach a nucleic acid target can be detected by a ligation assay. In one such format, the nucleic acid target hybridizes with an immobilized nucleic acid and labeled oligonucleotide complementary to an adjacent segment of the target is ligated to the immobilized nucleic acid. A target nucleic acid can also be detected by polymerase mediated incorporation of labeled nucleotides. In one such format, a target nucleic acid hybridizes to an immobilized nucleic acid and the immobilized nucleic acid is extended using the target nucleic acid as a template.

Irrespective whether the signal arises as a result of direct or indirect labeling of the target and with or without amplification, the signal can be detected with a suitable signal detection device. After optional washing to remove unbound and nonspecifically bound probe, the signal intensity for a sample can be determined for each polymer n the array. For fluorescent labels, hybridization intensity can be determined by, for example, a scanning confocal microscope in photon counting mode. Appropriate scanning devices are described by e.g., U.S. Pat. No. 5,578,832; U.S. Pat. No. 5,631,734 and U.S. Pat. No. 5,324,633 and are available from Affymetrix, Inc. under the GeneChip® mark.

Polymer arrays have many uses including gene expression monitoring, profiling, library screening, genotyping, copy number determination and diagnostics. Methods of gene expression monitoring and profiling are described in U.S. Pat. Nos. 5,800,992, 6,013,449, 6,020,135, 6,033,860, 6,040,138, 6,177,248 and 6,309,822. Genotyping methods, and uses thereof, are disclosed in U.S. Pat. Nos. 5,856,092, 6,300,063, 5,858,659, 6,284,460, 6,361,947, 6,368,799, 6,333,179, and 6,872,529. Other uses are described in U.S. Pat. Nos. 5,871,928, 5,902,723, 6,045,996, 5,541,061, and 6,197,506.

Arrays can be used to detect, quantify and or characterize the binding specificity of one or more target molecules or analytes in a sample. Nucleic acid arrays can be used to detect nucleic acid samples (e.g., nucleic acids characteristic of bacterial or viral pathogens), to identify one or more mutations in a target nucleic acid (see, e.g., WO 95/11995), to sequence de novo EP 562047 or resequence (WO 95/11995) a target nucleic acid or to monitor expression of a populations of nucleic acids, particularly mRNA or derivatives thereof. Nucleic acid arrays can also be used to screen potential drugs for a desired nucleic acid binding specificity. For example, genetic markers can be sequenced and mapped using Type-IIs restriction endonucleases as disclosed in U.S. Pat. No. 5,710,000. Other applications include chip based genotyping, species identification and phenotypic characterization, as described in U.S. Pat. No. 6,228,575 and U.S. Ser. No. 08/629,031, filed Apr. 8, 1996. Gene expression may be monitored by hybridization of large numbers of mRNAs in parallel using high density arrays of nucleic acids in cells, such as in microorganisms such as yeast, as described in Lockhart et al., Nature Biotechnology, 14: 1675-1680 (1996) and WO97/10365, the disclosure of which is incorporated herein. Bacterial transcript imaging by hybridization of total RNA to nucleic acid arrays may be conducted as described in Saizieu et al., Nature Biotechnology, 16: 45-48, 1998. Sequencing of polynucleotides can be conducted, for example, as taught in U.S. Pat. No. 5,547,839, the disclosure of which is incorporated herein in its entirety for all purposes. The nucleic acid arrays may be used in many other applications including detection of genetic diseases such as cystic fibrosis, diabetes, and acquired diseases such as cancer, as disclosed in U.S. patent application Ser. No. 08/143,312. For example, the present arrays can be used as chips for bridge amplification. The bridge amplification method refers to a solid phase replication method in which primers are bound to a solid phase, e.g., the present arrays. The primers can be synthesized on the present arrays as described herein. During the annealing step, the extension product from one bound primer forms a bridge to the other bound primer.

Peptide arrays can be used to detect analytes in a sample, particularly antibodies or other proteins. Peptide arrays can also be used to screen potential drugs for a desired target specificity. Peptide arrays can also be used to characterize complex immune responses or other disease states by a characteristic binding pattern to the array.

Due to their high surface stability, the present arrays are suitable platforms for sequencing nucleic acids. For example, the present arrays can be used as chips for bridge amplification. The bridge amplification method refers to a solid phase replication method in which primers are bound to a solid phase, e.g., the present arrays. The primers can be synthesized on the present arrays as described herein. During the annealing step, the extension product from one bound primer forms a bridge to the other bound primer.

### XIII. Other Applications

Self-assembled monolayers have many applications other than arrays. For example, self-assembled monolayers can be used for immobilizing catalysts on SAMs to provide a defined presentation of a specific face of a molecule (see, e.g., Bartz et al., J. Am. Chem. Soc., 121, 4088, 1999). SAMs can also be used to modify the surface properties of electrodes for electrochemistry, general electronics, and various nanoelectromechanical systems (NEMS) and microelectromechanical systems (MEMS) (see, e.g., Love et al., Chem. Rev. 105:1103-1170, 2005). Thin-filmed SAMs can also be used to functionalize a nanostructure useful in making biosensors or other MEMS devices that need to separate one type of molecule from its environment. For example, a magnetic nanoparticle coated with a SAM that binds to the fungus can be used to bind to the fungus in a blood stream and remove the fungus by magnetically driving it out of the blood stream into a nearby laminar waste stream (see Yung et al., Lab on a Chip, 9:1171-1177, 2009).

### EXAMPLES

### Example 1

### Preparation of N-(2-hydroxyethyl)-N,N-bis(trimethoxysilylpropyl)amine(hydroxyethyl bis-silane or “HEBS”)

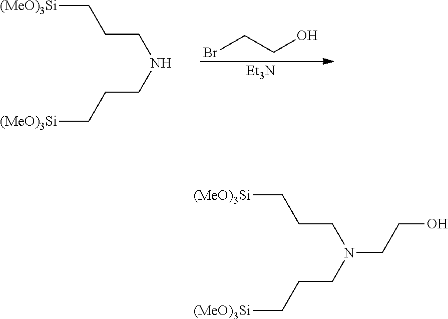

A mixture of 2-bromoethanol (3.0 g; 24 mmole), N,N-Bis-(3-(trimethoxysilyl)-propyl) amine (Gelest, 10 g; ˜28 mmole) and triethylamine (3.0 g; 4.2 ml; 30 mmole) in 50 ml of dry acetonitrile was refluxed under Ar for 8 hours, by which time GC-MS analysis indicated disappearance of the aminosilane. The solvent was evaporated and the residue stirred vigorously with 150 ml dry ether and allowed to stand at room temperature for 4 hours to separate insoluble byproducts. The clear supernatant was filtered and evaporated; and the crude product again taken up in ether (50 ml). Dry hexanes (50 ml) was then added with vigorous stirring, and the mixture allowed to settle for 2 more hours before a final filtration and evaporation to yield 10 g (90%) of the product as a yellow oil. ¹H-NMR (400 MHz; CDCl₃) δ(ppm): 3.74 (2H, t, J=5.2 Hz); 3.58 (8H, s); 3.56 (5H, s); 3.51 (4H, s); 2.55 (4H, t, J=5.2 Hz); 2.44 (2H, t, J=5.8 Hz); 1.50-1.64 (4H, m); 0.59-0.65 (2H, m); 0.53-0.58 (2H, m). MS (EI): 354 (M-CH₃OH); 322 (M-2CH₃OH).

### Example 2

### Preparation of 2-Bromo-2-methyl-N,N-bis-(3-trimethoxysilanylpropyl)propionamide

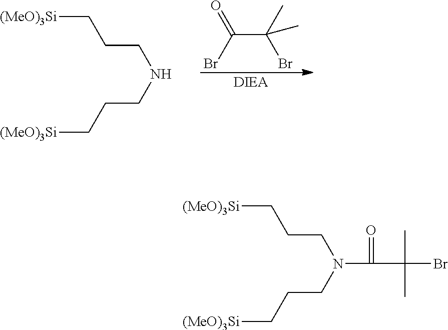

A solution of 2-Bromo-2-methylpropionyl bromide (37 ml; 70 g; 300 mmole) in 150 ml of dry ether was added dropwise over a period of about 45 minutes to an ice-cooled, stirring solution of N,N-Bis-(3-(trimethoxysilyl)propyl)amine (105 ml; 108g; 300 mmole; 95%, Gelest) and N,N-(diisopropyl)ethylamine (40.6 g; 55 ml; 315 mmole) in 300 ml dry ether under nitrogen. After stirring at ambient temperature overnight, the solution was filtered and evaporated to dryness. The residue was re-dissolved in 500 ml of dry ether, allowed to stand at 4° C. for 6 hr to precipitate additional byproducts, and finally filtered and evaporated again to yield 115g (78%) product as an orange oil. ¹H-NMR (400 MHz; CD₃OD) δ(ppm): 3.55 (18H, s); 3.55-3.70 (2H, br m); 3.20-3.35 (2H, br m); 1.94 (6H, s); 1.55-1.85 (4H, 2×br m); 0.56-0.66 (4H, br m).

### Example 3

### Self-Assembled Monolayers

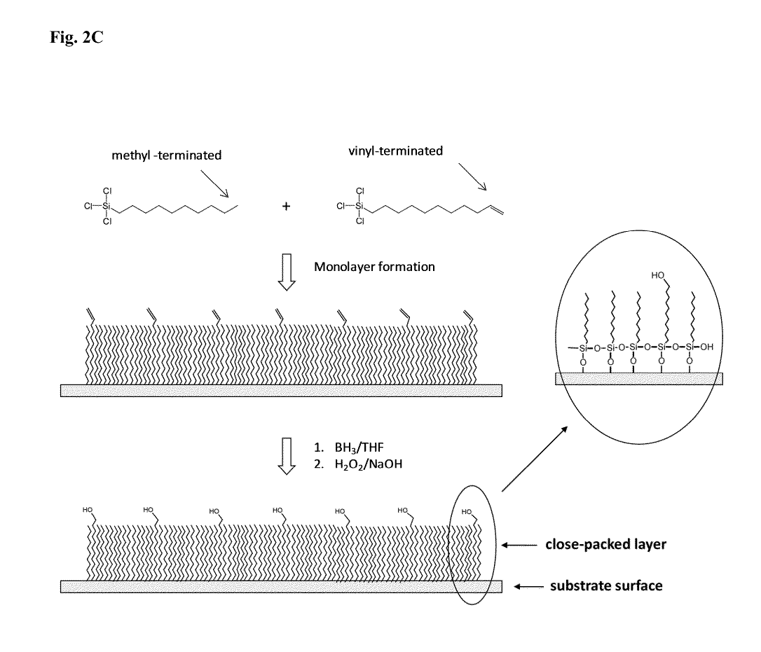

FIGS. 2A, B illustrate synthesis of a self-assembled monolayer using an alkylsilyl compound having various substituents or a mixture thereof. For example, an alkylsilyl compound having —OH functional group or an ether form —OR (FIG. 2A) or an ester form —O—CO—R can be used (FIG. 2B). An alkylsilyl compound having a precursor functional group (e.g., a vinyl group) that can be converted into a functional group (e.g., hydroxyl group) can also be used for synthesizing a monolayer (FIG. 2C). In addition, an alkylsilyl compound not having a functional group, e.g., one having methyl at the terminus distal to the substrate, can also form a monolayer.

Substrate Cleaning Procedure:

Fused silica substrates (Schott USA) were cleaned by soaking/agitating in Nanostrip (Cyantek, Fremont, Calif.) for 20 minutes. Substrates were then rinsed thoroughly with deionized water and spin-dried for 5 minutes under a stream of nitrogen at 35° C. The freshly cleaned substrates were stored under nitrogen and silanated within 24 hours.

Silanation Procedures:

(A) Silanation of silica substrates with trialkoxysilanes such as HEBS was carried out by immersion with gentle agitation in a freshly prepared 2% (wt/vol) solution of the silane in 95:5 ethanol-water for 15-30 minutes. The substrates were rinsed thoroughly with 2-propanol, then deionized water; and then spin-dried under a stream of clean dry nitrogen for 5 minutes at 35 C. Another HEBS—based coating, providing reduced surface hydroxyl density (denoted “1:99”), was prepared with a 1:99 (mole ratio) mixture of HEBS and the non-functional silane 1,2-bis(trimethoxysilyl)ethane (BTMSE), diluted to 2% (w/v) in 95:5 ethanol-water, as described in US Patent Application 20090215652. (B) SAM Silanation Procedures: SAMs were applied to freshly cleaned substrates by treatment with a 1 mM solution of the alkyltrichlorosilanes in an inert, nonpolar anhydrous solvent such as toluene (TOL) or dichloromethane (DCM) for 8 hours under a nitrogen atmosphere at room temperature. The treated substrates were then rinsed multiple times with fresh silanation solvent, then ethanol; and then spin-dried under a stream of clean dry nitrogen for 5 minutes at 35 C.

Monolayers were prepared on fused using the following alkyl trichlorosilanes and mixtures thereof: 1). 100% CH₃CO₂(CH₂)₁₁SiCl₃(100% 11-acetoxyundecyltrichlorosilane or “acetoxy” silane); 2). 100% CH₃(CH₂)₉SiCl₃(100% “methyl” silane); 3). 100% CH₃(CH₂)₉SiCl₃ followed by BH₃—H₂O₂ treatment (100% methyl silane/BH₃—H₂O₂); 4). 100% CH₂═CH(CH₂)₉SiCl₃ (100% vinyl silane); 5). 100% vinyl silane treated with BH₃—H₂O₂ (100% vinyl silane/BH₃—H₂O₂); 6). 50% CH₂═CH(CH₂)₉SiCl₃/50% CH₃(CH₂)₉SiCl₃ (50% vinyl silane); 7). 50% vinyl silane treated with BH₃—H₂O₂ (50% vinyl silane/BH₃—H₂O₂); 8). 10% CH₂═CH(CH₂)₉SiCl₃/90% CH₃(CH₂)₉SiCl₃ (10% vinyl silane); 9). 10% Methyl/vinyl silane treated with BH₃—H₂O₂ (50% vinyl silane/BH₃—H₂O₂); 10). 4% CH₂—CH(CH₂)₉SiCl₃/96% CH₃(CH₂)₉SiCl₃ (4% vinyl silane); 11). 4% vinyl silane treated with BH₃—H₂O₂ (4% vinyl silane/BH₃—H₂O₂); 12). 2% CH₂═CH(CH₂)₉SiCl₃/98% CH₃(CH₂)₉SiCl₃ (2% vinyl silane); 13). 2% vinyl silane treated with BH₃—H₂O₂ (2% vinyl silane/BH₃—H₂O₂); 14). 0.5% CH₂═CH(CH₂)₉SiC1/99.5% CH₃(CH₂)₉SiCl₃ (0.5% vinyl silane); 15). 0.5% vinyl silane treated with BH₃—H₂O₂ (0.5% vinyl silane/BH₃—H₂O₂); 16). 100% Br(CH₃)₂CCO₂(CH₂)₁₁SiCl₃.

Conversion of terminal alkene groups on SAMs to hydroxyl groups via hydroboration-oxidation (BH₃—H₂O₂) was carried out using the protocol of Wasserman, et al. (Langmuir 1989, 5: 1074). Substrates with monolayers having terminal vinyl functional groups were treated with 1M BH₃-THF solution for 2 hours under nitrogen at room temperature. The monolayers were then rinsed twice with THF and immersed in an aqueous solution of 30% H₂O₂ and 0.1M NaOH for 3 minutes, then rinsed thoroughly with deionized water, then dried and stored under dry nitrogen.

Conversion of terminal acetoxy groups on SAMs to hydroxyl groups via treatment with sodium methoxide: Substrates coated with monolayers of 11-acetoxyundecyltrichlorosilane (“acetoxy” silane) were de-acetylated by treatment with a 0.1M solution of sodium methoxide in methanol (Aldrich) for 4 hours at room temperature under dry nitrogen. The substrates were then rinsed thoroughly with methanol and deionized water, then dried and stored under dry nitrogen.

SAM Multilayers:

FIG. 8 depicts the process used for the preparation of hydroxyl-terminated SAM multilayers: 11-acetoxyundecyltrichlorosilane was used to prepare an initial 100% acetoxysilane monolayer as described in Example 1. After de-acetylating the surface hydroxyl groups with methanolic sodium methoxide, the silanation and de-acetylation steps were repeated 1-3 more times to produce SAM coatings of 2-4 layers. Measured data for the resulting films are shown in Table 1.

TABLE 1

| | | | | Stability |
|---|---|---|---|---|
| | | | | (% retention of |
| | | | | fluorescence |
| | Contact | Film | Site | signal after 24 h |
| | Angle | Thickness | Density | in 6x SSPE at |
| SAM_A100 | By H₂O | (Å) | (pmol/cm²) | 45° C.) |
| Single | 65° | 13.39 | 109.0 | 3% |
| Monolayer | | | | |
| Multi-Layers | 68° | 29.45 | 137.6 | 120% |
| (2 Layers) | | | | |
| Multi-Layers | 69° | 42.34 | 122.4 | 105% |
| (3 Layers) | | | | |

Based on measurements obtained on an Alpha-SE Ellipsometer (JA Woolam Co., Lincoln, Nebr.), the observed thickness of the resulting films was proportional to the number of layers (14±1 Å per layer), as expected.

The measured density of surface hydroxyl groups and contact angles for the single- and multi-layer SAMs are relatively independent of the number of layers, as only the terminal hydroxyl groups of the top-most layer are exposed.

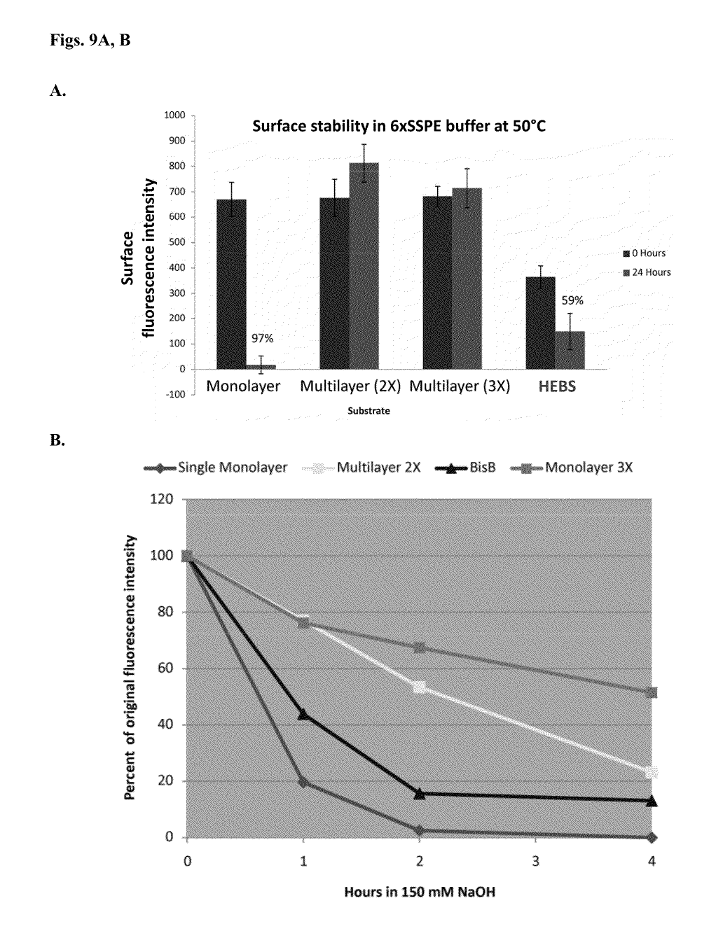

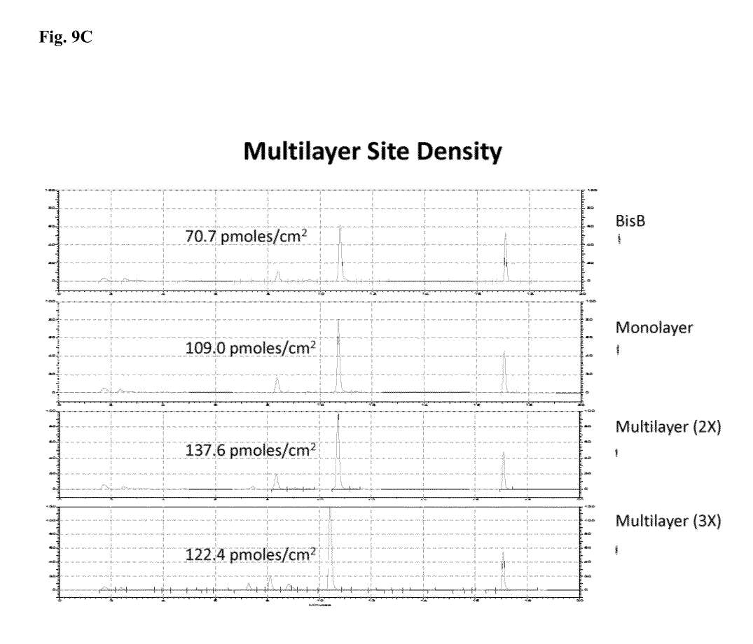

The multilayer films are much more resistant towards degradation in aggressive aqueous environments. FIG. 9 illustrates the stability of single- and multilayer SAMs based on surface fluorescence in (A) 6×SSPE buffer at 45° C.; and in (B) 150 mM NaOH at 22° C.

Further modification of SAM arrays with extension linker molecules and capping agents: For the purposes of fabricating oligonucleotide probe arrays, it is usually advantageous to attach a functionalized hydrophilic “extension linker” molecule to the surface hydroxyl groups of silanated substrates, prior to synthesizing the array of oligonucleotide probes (Southern E M, et al. Genomics 1992, 13:1008-17; Pease A C, et al. Proc. Natl. Acad. Sci. USA 1994, 91, 5022-26). This was performed using a protected hexaethylene glycol phosphoramidite linker using standard phosphoramidite coupling protocols as described previously as (McGall, et al. JACS 1997; Methods Molec Biol 2002):

### MeNPOC-HEG-CEP

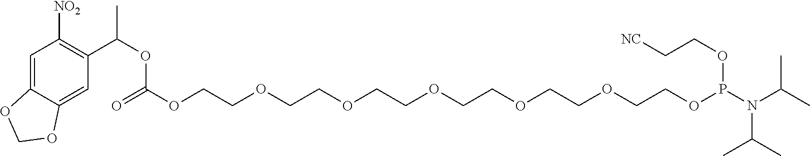 [SMILES: CC(OC(=O)OCCOCCOCCOCCOCCOCCOP(OCCC#N)N(C(C)C)C(C)C)c1cc2c(cc1[N+](=O)[O-])OCO2]

For some silane coatings and monolayers, the density of reactive functional sites on the surface was also reduced at this stage by using a mixture of functional hydrophilic linker phosphoramidite with a non-functional analog at varying ratios, prior to activating and coupling to the surface. For this purpose, an mPEG phosphoramidite was prepared from triethyleneglycol monomethyl ether and 2-cyanoethyl N,N,N′,N′-tetraisopropylphosphordiamidite using standard protocols (see Grossman, P D; et al. PCT Int. Appl. (1993), WO 9320239); δ=3.92-3.58 (14H, m, OCH₂); 3.56-3.53 (2H, m, C₁₋₂CN); 3.38 (3H, s, OCH₃); 2.72-2.59 (2H, m, NCH(CH₃)₂); 1.192, 1.175 (6H, 2d, J=, NCH(CH₃)₂).

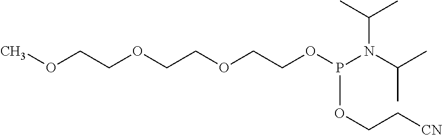 [SMILES: COCCOCCOCCOP(OCCC#N)N(C(C)C)C(C)C]

MTEG-CEP:

### Example 4

### Measurement of Contact Angles of Various Self-Assembled Monolayers

Measurement of Contact Angles:

contact angles were measured using a VCA2500XE goniometer (AST Products, Billerica, Mass.).

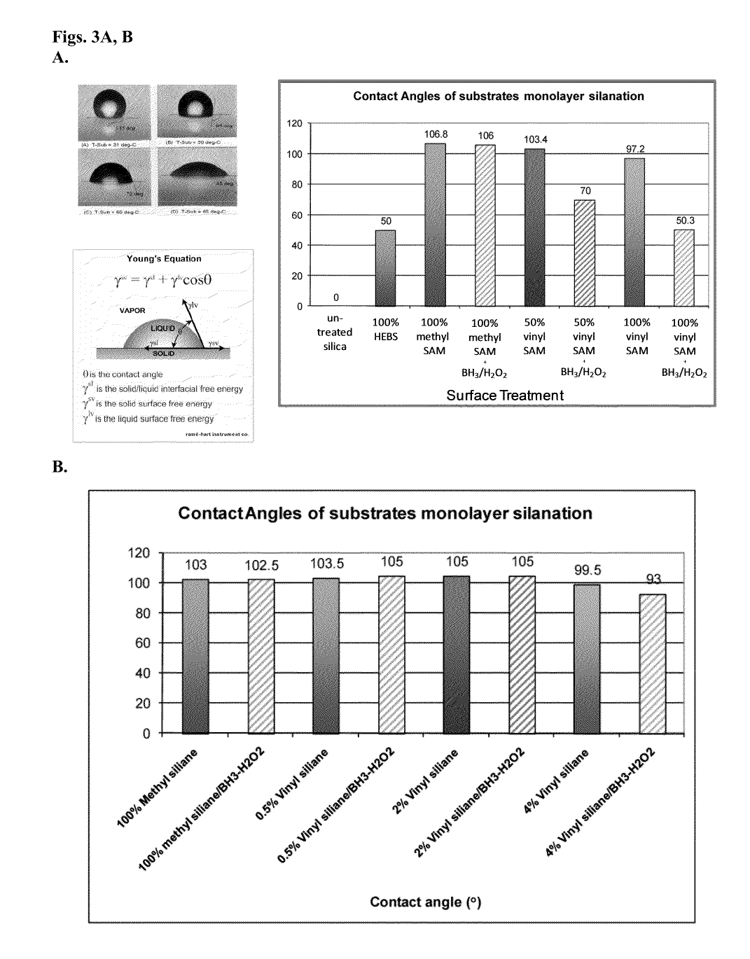

FIG. 3A illustrates contact angles measured for HEBS-silanized substrate and various self-assembled monolayers including 1). 100% methyl silane; 2). 100% methyl silane/BH3-H2O2; 3). 1:1 Methyl/Vinyl silane; 4). 1:1 Methyl/Vinyl silane/BH3—H₂O₂; 5). 100% vinyl silane; and 6). 100% vinyl silane/BH₃—H₂O₂.

FIG. 3B illustrates contact angles measured self-assembled monolayers containing varying proportions of including 1). CH₃ (CH₂)₉SiCl₃ (100% methyl silane); 2). 100% CH₃ (CH₂)₉SiCl₃ silane treated with BH₃—H₂O₂ (100% methyl silane/BH₃—H₂O₂); 3). 0.5% CH₂═CH(CH₂)₉SiCl₃/99.5% CH₃(CH₂)₉SiCl₃ (0.5% vinyl silane); 4). 0.5% vinyl silane treated with BH₃—H₂O₂ (0.5% vinyl silane/BH₃—H₂O₂); (5) 2% CH2=CH(CH₂)₉SiCl₃/98% CH₃ (CH₂) 9SiCl₃ (2% vinyl silane); (6) 2% vinyl silane treated with BH₃—H₂O₂ (2% vinyl silane/BH₃—H₂O₂); (7) 4% CH2=CH(CH₂)₉SiCl₃/96% CH₃ (CH₂)₉SiCl₃ (4% vinyl silane); (8) 4% vinyl silane treated with BH₃—H₂O₂ (4% vinyl silane/BH₃—H₂O₂).

As expected, the methyl- and vinyl-terminated SAMs initially exhibit high contact angles, reflecting a high surface energy or hydrophobicity. After hydroboration-oxidation, the SAMs containing vinyl-terminated silane exhibit significantly decreased surface energy/hydrophobicity due to the polar nature of the resultant surface hydroxyl groups. The magnitude of the decrease in contact angle is proportional to the percentage of terminal vinyl groups incorporated into the monolayer (as predicted from the relative ratio of vinyl to methyl silane used in the silanation).

### Example 5

### Measurement of Functional Site Density of Various Self-Assembled Monolayers

Measurement of Functional Site Density:

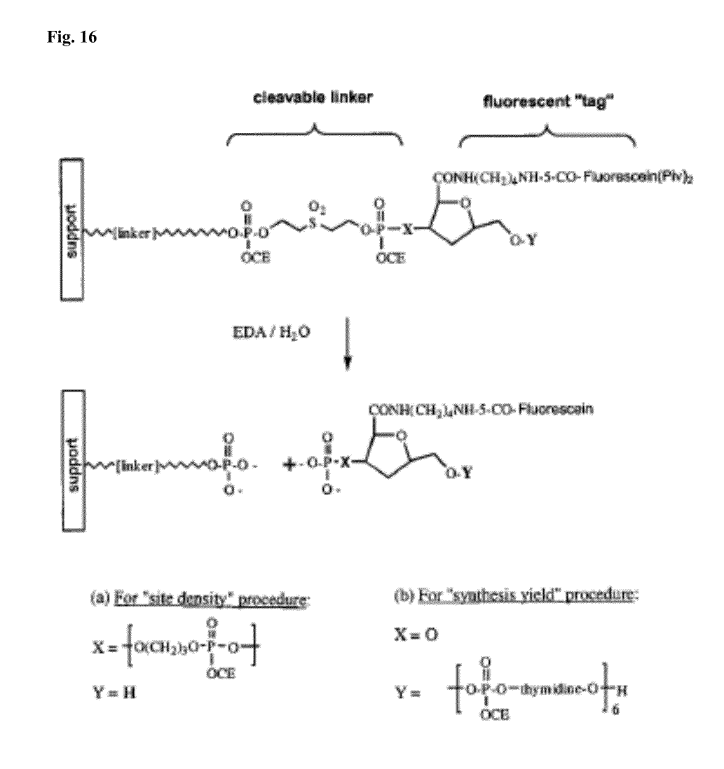

The density of reactive surface hydroxyl groups was measured by a fluorescence-based HPLC method described previously (U.S. Pat. No. 5,843,655) and as shown in FIG. 16. FIG. 16 also shows a similar procedure for measuring coupling efficiency or synthesis yield. Basically, a cleavable linker (5′-phosphate-ON reagent, ChemGenes Corp.) was attached to the surface using standard phosphoramidite protocols, followed by a spacer molecule (C3 spacer phosphoramidite, Glen Research, Sterling, Va.) and the fluorescent labeling reagent 5-carboxyfluorescein phosphoramidite, (McGall G H, et al. Eur Pat Appl 1999; EP 0967217). The substrate was then cut into ˜1 cm² pieces, weighed, placed in a glass vial, and then treated with 1:1 (by vol) ethylenediamine/water for 4 h at 50° C. to cleave the linker and release 3′-pC3-fluorescein-5′ from the support into the solution. An internal standard was added and the resulting solution was and analyzed by HPLC. The internal standard, 3′-pC3C3-fluorescein-5′, was prepared separately on an Expedite® oligonucleotide synthesizer (Applied Biosystems, Foster City, Calif.) and quantified independently by UV-Vis spectrometry on an Agilent Model 8453 diode array spectrophotometer.

HPLC analyses were performed on a Shimadzu Prominence HPLC system (Shimadzu Scientific Instruments, Kyoto, Japan) employing an ion-exchange column (DNA PAC PA-100 (Dionex, Sunnyvale, Calif.), and fluorescence detection at 520 nm. Elution was performed with a linear gradient of 0.4 M NaClO₄ in 20 mM Tris pH 8 (or other similar buffer system), at a flow rate of 1 mL min⁻¹. Any fluorescein molecules adsorbed on the surface noncovalently will appear first in the chromatogram, followed by fluorescein that has coupled to the C3 spacers (3′-pC3-fluorescein-5′), and finally the internal standard (3′-pC3C3-fluorescein-5′). Integration of HPLC peak areas was used to quantify the total cleaved fluorescein and thereby the total site density. The surface site density per unit area was determined by dividing the total sites by the surface area available for synthesis (calculated from the weight of the glass sample).

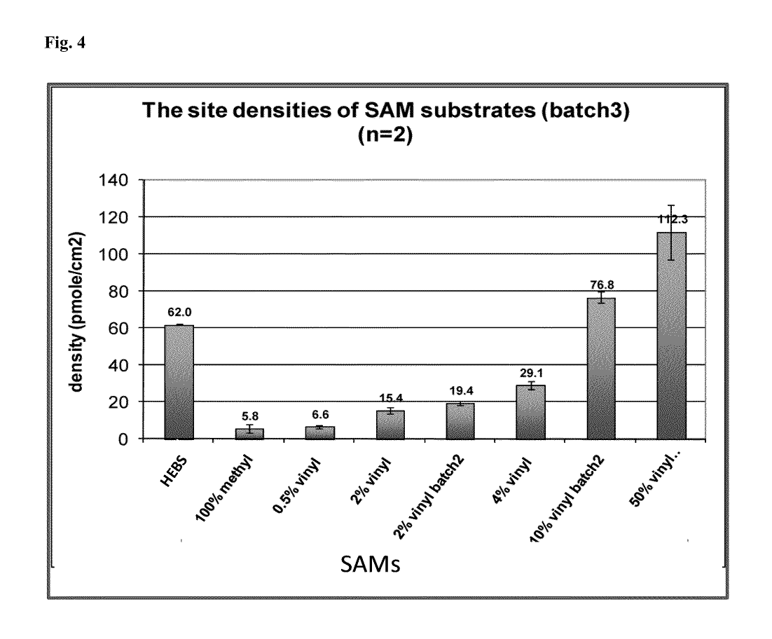

FIG. 4 shows functional site density measured for HEBS-silanized substrate and various self-assembled monolayers including 1). 100% methyl silane; 2). 0.5% vinyl silane; 3) 2% vinyl silane; 4) 4% vinyl silane; 5) 10% vinyl silane; and 6) 50% vinyl.

As expected, after hydroboration-oxidation, vinyl-terminated SAMs exhibited hydroxyl densities which increase in proportion to the percentage of vinyl groups incorporated into the monolayer that is predicted from the relative ratio of vinyl to methyl silane used in the silanation.

### Example 6

### Oligonucleotide Synthesis on SAM-Coated Substrates

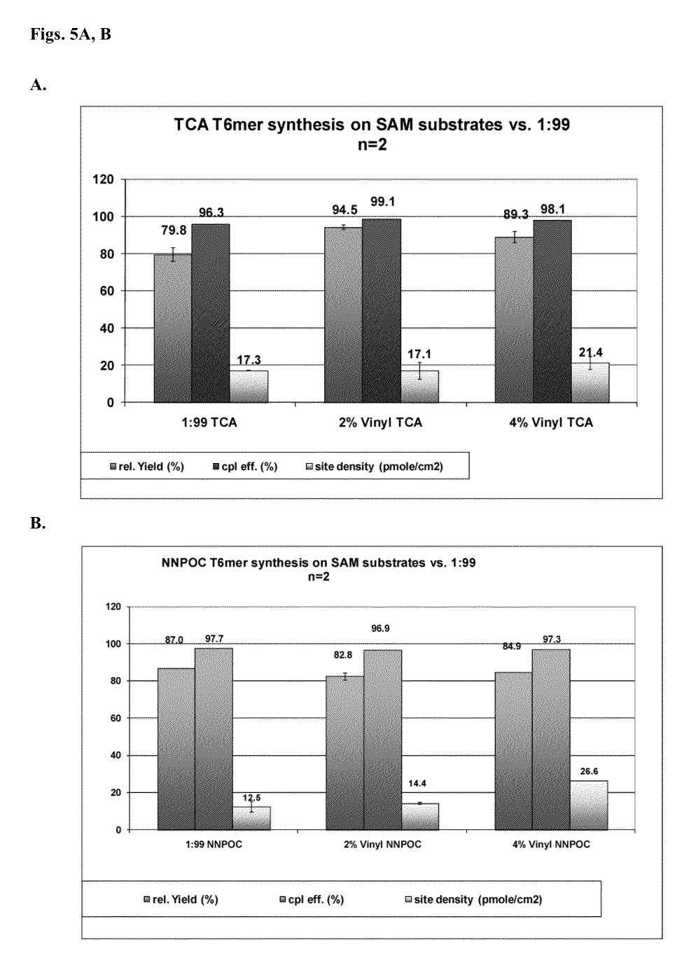

FIGS. 5A, B show that both standard TCA/DMT chemistry (A) and photochemical synthesis (B) perform exceptionally well on the surfaces of self-assembled monolayers. The efficiency of oligonucleotide synthesis was determined by examining the yield of a short homopolymer, such as hexathymidylate. The cleavable linker and fluorescein phosphoramidite were coupled to substrates, as described above, and then six synthesis cycles of 5′-(DMT or NNPOC)-thymidine-3′-phosphoramidites were performed using standard “detritylation” or photolytic synthesis cycles (G H McGall and J A Fidanza, Methods in Molecular Biology DNA Arrays Methods and Protocols, edited by J. B. Rampal Humana, Totowa, N.J., 2001, pp. 71-101.)

The labeled homopolymer was then cleaved from the support in 1:1/vol ethylenediamine/water for 4 h at 50° C., the internal standard was added (see above), and the solution was analyzed by HPLC as described above. The relative synthesis yield (RSY) on the surface was calculated by dividing the integrated area of the labeled hexamer peak by the total area of all products cleaved from the surface. The RSY is indicative of the efficiency of the step-by-step base-coupling reactions on the solid support.

The RSY and stepwise cycle efficiencies were high for all of the silanated substrates evaluated.

### Example 7

### Hydrolytic Stability of Self-Assembled Monolayers

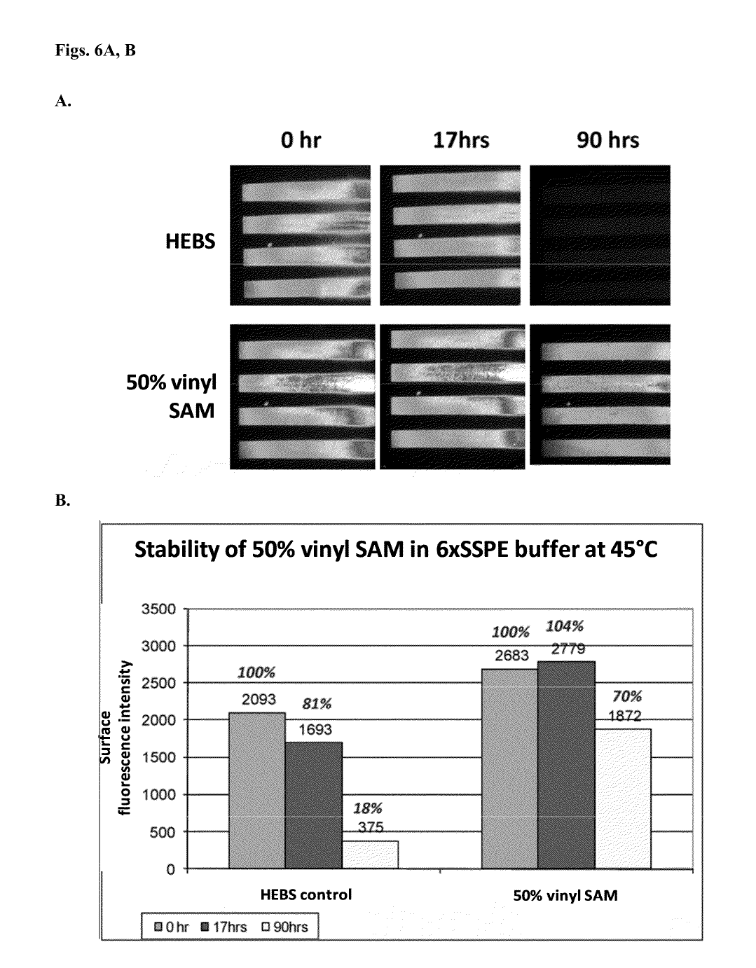

FIGS. 6A, B illustrate that self-assembled monolayers substrates have exceptional hydrolytic stability as compared to HEBS substrates. Monolayer stability in heated aqueous buffers was determined by a surface fluorescence as described in U.S. Pat. No. 6,410,675: Surface hydroxyl sites on the silanated substrates were “labeled” with fluorescein in a pattern of horizontal stripes by first coupling a MeNPOC-HEG linker phosphoramidite, image-wise photolysis of the surface to remove the MeNPOC, then coupling to the photo-deprotected linker sites a 1:20 mixture of 5-carboxyfluorescein CX phosphoramidite (Biogenex, San Ramon, Calif.) and DMT-T phosphoramidite (ThermoFisher, Milwaukee, Wis.), and finally deprotecting the surface molecules in 1:1 ethylenediamine-ethanol for 4 hr. These steps were conducted using standard protocols, as described in McGall et al., J. Am. Chem. Soc., 119:5081-5090 (1997), the disclosure of which is incorporated herein.

The pattern and intensity of surface fluorescence was imaged with a specially constructed scanning laser confocal fluorescence microscope using a custom telecentric objective lens with a numerical aperture of 0.25 focusing 5 mW of 488-nm argon laser light to a 3-lm-diameter spot, which was scanned by a galvanometer mirror across a 14-mm field at 7.5 lines per second [U.S. Pat. No. 5,578,832]. Fluorescence collected by the objective was directed by the galvanometer mirror, filtered by a dichroic beam splitter (505 nm) and a bandpass filter (515-545 nm), focused onto a confocal pinhole, and detected by a photomultiplier. Photomultiplier output was digitized to 12 bits. A 512 by 512 pixel image at a pixel size of 27.2 μm was generated. Automated Visual Inspection (AVI), a PC-based image processing system (P. Fiekowsky, Los Altos, Calif., USA), was used to process and manipulate the fluorescence image data. Output fluorescence intensity values are proportional to the amount of surface-bound fluorescein, so that relative yields of free hydroxyl groups within different regions of the substrate could be determined by direct comparison of the observed surface fluorescence intensities. All intensity values were corrected for nonspecific background fluorescence, taken as the surface fluorescence within the non-illuminated regions of the substrate.

To determine the relative stability of the silicon compound coatings, substrates were gently agitated on a rotary shaker in either 6×SSPE aqueous buffer pH 7.4 (Cambrex, Rockland, Me.), at 45° C., or 150 mM aqueous NaOH at 22° C. Periodically, the substrates were removed from the buffer and re-scanned to measure the amount of surface fluorescence due from fluorescein remaining covalently bound to the surface.

As shown in FIG. 6A, for both HEBS and SAM coatings, substantial levels of signal from the fluorescein label remained bound to the substrate after prolonged exposure to aqueous phosphate buffer at elevated temperature. This level of stability is dramatically improved over surface coatings using either N-(3-triethoxysilylpropyl)-4-hydroxybutyramide) or N-(3-triethoxysilylpropyl)-N,N-bis(2-hydroxyethyl)amine, two silanes commonly used for DNA array synthesis (G H McGall et al., J. Am. Chem. Soc. 1997, 119:5081-5090; G H McGall and J A Fidanza, Methods in Molecular Biology DNA Arrays Methods and Protocols, edited by J. B. Rampal Humana, Totowa, N.J., 2001, pp. 71-101; SL Beaucage. Current Methods In Medicinal Chemistry 2001, 8:1213-44; M C Pirrung Angew. Chem. Int. Edn. Engl. 2002, 41:1276-89; C G Lausted, et al. Methods Enzymol. 2006, 410:168-89; S Chen, et al., Langmuir 2009, 25:6570-5; B Y Chow, et al. Proc Natl. Acad Sci USA 2009, 106:15219-24).

FIGS. 9A and 9B show the comparative hydrolytic stabilities of various silane monolayers and multilayers in 6×SSPE buffer (45° C.) and in 150 mM aqueous NaOH (22° C.), respectively. The SAM multilayers exhibit markedly improved stability relative to either HEBS or single-layer SAM coatings, as indicated by the maintenance of higher levels of surface fluorescence intensity after treatment.

### Example 8

### Hybridization to DNA Probes Synthesized on Functionalized SAM Surfaces

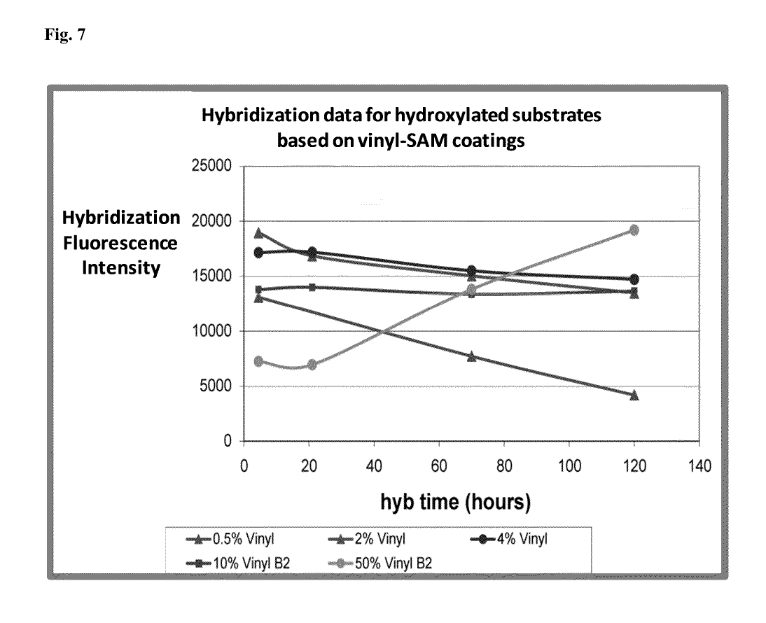

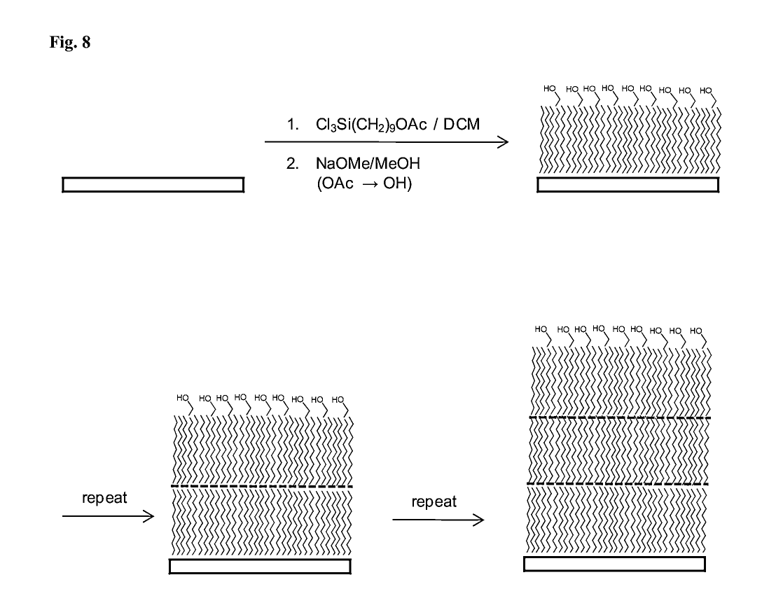

FIG. 7 illustrates oligonucleotide synthesis and hybridization kinetics on self-assembled monolayers having various functional site density. Fused silica substrates were modified with hydroxylated SAM coatings having a range of surface hydroxyl densities, as described in example 1. A single test probe sequence was synthesized on these substrates in a checkerboard or stripe pattern using NNPOC phosphoramidite monomers (see US20110046344, US20110028350, US20100324266, US20090076295, U.S. Pat. No. 6,147,205, U.S. Pat. No. 7,470,783, U.S. Pat. No. 6,566,515 and U.S. Pat. No. 8,034,912) and photolithographic synthesis (G H McGall and J A Fidanza, Methods in Molecular Biology DNA Arrays Methods and Protocols, edited by J. B. Rampal Humana, Totowa, N.J., 2001, pp. 71-101). The test sequence was the 20-mer sequence 3′-(HEG)-AGG TCT TCT GGT CTC CTT TA-5′, with the 3′ end attached via a hexaethylene glycol spacer to the substrate surface via phosphodiester bonds. For measurements of hybridization kinetics, the array was incubated with a complementary 3′-fluorescein-labeled 20-mer oligonucleotide target at a concentration of 2 nM in MES buffer pH 6.8 (0.1M 2-[N-morpholino]ethanesulfonic acid, 0.89M NaCl, and 0.03M NaOH), held at a controlled temperature of 45° C. Fluorescence scans (following experimental procedures as described in example 7) were taken at intervals to determine surface fluorescence from bound target molecules as a function of time. All fluorescence hybridization intensities were background corrected by subtracting the baseline noise fluorescence signal from a region of the sample with no probe synthesis.

As is apparent in FIG. 7, SAM substrates showed very stable fluorescent signal due to bound hybridized target over extended periods of time. Exceptions were the SAMs with extremely low (0.5%) or very high (>50%) hydroxyl content, which showed hybridization signals decreasing and increasing with time, respectively. The latter effect is due to a retardation of the hybridization kinetics resulting from the very high density of surface probe molecules (A W Peterson, et al. Nucl. Acids Res. 2001, 29:5163-8).

### Example 9

### Multilayer Exhibits Exceptional Stability and Increased Density of Tail Groups

FIGS. 9A, B illustrate the stability of monolayer and multilayer in 6×SSPE buffer at 45° C. (FIG. 9A) and 150 mM NaOH at 22° C. (FIG. 9B). Stability of monolayer and multilayer was measure using the experimental procedures as outlined in Example 7.

FIG. 9C illustrates the measured density of surface hydroxyl groups for HEBS and multilayers derived from “100% acetoxy silane.” The density of surface hydroxyl groups was measured using the experimental procedures as outlined in Example 5.

### Example 9a

### Synthesis Procedures for the Co-Polymer Brush on Silanated Substrate

(A) Substrates were prepared with surface-bonded 2-bromoisobutyryl initiator groups for ATRP by three methods:

1. Freshly cleaned fused silica substrates were and gently agitated in a 1% (v/v) solution of 2-Bromo-2-methyl-N,N-Bis-(3-trimethoxysilanylpropyl)-propionamide in toluene at room temperature for 1 hour; rinsed with toluene, then isopropanol; and finally spin-dried under a stream of clean dry nitrogen at 35° C.

2. Substrates were first coated with a “100% acetoxy” SAM and then de-acetylated with methanolic sodium methoxide (example 1). The resulting hydroxylated SAM was then acylated by gentle agitation in a freshly-prepared solution of 0.1M 2-bromisobutyryl chloride in dry pyridine-acetonitrile (1:9 v/v) under argon for 1-4 hours. The substrates were rinsed thoroughly with acetonitrile, then isopropanol; and finally spin-dried under a stream of clean dry nitrogen at 35° C.

3. Substrates were directly silanated in dichloromethane (DCM), using the general procedure described in example 1, with a 1 mM solution of 11-[(2-Bromo-2-methyl)propionyloxy]undecyl]trichlorosilane (Matyjaszewski, et al. Macromolecules 2009, 42: 9523-7):

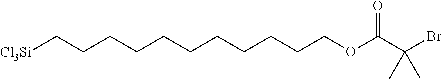

(B) Protocol for forming linear acrylate polymer brush coatings comprising of copolymers of monomers by surface-initiated ATRP.

“ATRP2c”: Co-polymer of 2-Hydroxyethyl acrylate (HEA)—Ethylene glycol methyl ether methacrylate (EGMEM), using different mole ratios: 0.0:1.0; 0.1:0.9; 0.2:0.8; 0.5:0.5; 0.8:0.2; 1.0:0.

### ATRP2c

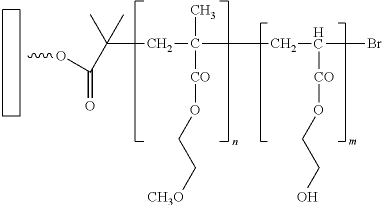

Reagents:

CuBr: Sigma-Aldrich, Cat#212865; PMDETA (N,N,N′,N″,N″-Pentamethyldiethylenetriamine): TCI America, Cat#P0881; EGMEM (Ethylene glycol methyl ether methacrylate): Sigma-Aldrich, Cat#4153324; 2-Hydroxyethyl acrylate: Sigma-Aldrich, Cat#292818; Inhibitor removers: Sigma-Aldrich, Cat#306312; Methanol: VWR, Cat# BDH1135-4LG; THF: VWR, Cat# BDH1149-4LG; DI water: Millipore.

Equipment:

Diaphragm pump: KNF Laboport; 2 L glass reactor: Chemglass; Glove bag: Sigma-Aldrich, Cat# Z530220; Heating mantel and temp. control; Stir plate, magnetic stirring bars; Rack; Solvent filter: Waters, Cat# PSL613578; Filter paper: S & S (#604, 18.5 cm); Other necessary glassware: beakers, funnel, Erlenmeyer flasks, Pasteur pipette.

### Preparation of Solutions

(1) Mix CuBr (1.28 g/9 mM) and PMDETA (5.6 ml/26 mM) in 200 ml 1:1 MeOH/water; Stir for 30 min, filter the catalyst solution (dark blue color) with a filter paper to remove trace solids; (2) Mix EGMEM (Ethylene glycol methyl ether methacrylate) with 10% (by weight) inhibitor removing resin, stir for 30 min; (3) Further remove the inhibitors from 2.2 with the inhibitor remover column, weigh out 43 g/0.3M of EGMEM; (4) Mix 2-Hydroxyethyl acrylate with 10% (by weight) inhibitor removing resin, stir for 30 min; (5) Further remove the inhibitors from 2.4 with the inhibitor remover column made from a Pasteur pipette, weigh out 3.9 g/0.33M of 2-Hydroxyethyl acrylate; (6) The above monomer quantities correspond to monomer mole ratio of 0.5:0.5. Quantities were adjusted accordingly for other mole ratios (1.0:0; 0.2:0.8; 0.8:0.2; 0:1.0).

Mixing:

(1) Mix the catalyst from 2.1 and the monomers from 2.3 and 2.5 in 800 ml of 1:1 MeOH/water and stir for 15 min, the solution is dark blue in color; (2) Degassing the solution with N₂ going through a solvent filter; (3) Vacuum the solution with a Diaphragm vacuum pump (˜20 mmHg) connecting to a dry ice trap system for 10 min, equilibrate pressure with N₂ and seal.

Polymerization

(Note: the ATRP reaction is negatively affected by air/oxygen. Measure must be taken to remove and exclude all oxygen): (1) Under an oxygen/air excluded environment, put the substrates into the monomer solution 3.3 to initiate the ATRP polymerization. Substrates should be completely submerged; (2) Polymerization is allowed to proceed at 20-70° C. for 18 hours with magnetic stirring, under positive pressure of Ar₂.

Washing:

(1) Transfer the substrates into 1:1 MeOH/THF (total ˜1.2 L) for overnight wash with gentle agitation, discard the polymerization solution (dark blue color with slightly cloudy); (2) Further wash the substrates with fresh 1:1 MeOH/THF for 10 min; (3) Dried the substrates with gentle stream of clean dry Ar at 35° C.; (4) Substrates should appear smooth and defect free by visual inspection; (5) Store the coated substrates under Ar.

ATRP-2c/Amide:

The same procedure described above for ATRP-2c/Ester was carried out, using the acrylamide monomers N-2-hydroxyethyl acrylamide (HEAA) and ethylene glycol methyl ether acrylamide (EGMEA) in a 1:9 ratio.

Characterization:

Film thickness: film thickness was determined using an Alpha-SE Spectroscopic Ellipsometer (J Woollam Assoc). Typical film thickness of ATRP 2c: 879±435 Å.

Contact angle: measure the contact angle with VCA 2500XE Video Contact Angle system. Typical contact angle of ATRP 2c: 63±2°.

FT-IR spectra: Nicolet NEXUS 470 FT-IR system. The spectra of substrates coated with thin films of polyacrylate ester brush (ATRP-2c) exhibited a prominent absorption peak at 1720 cm⁻¹, which is characteristic of the ester carbonyl stretching mode.

Surface area hydroxyl site density was measured using the same experimental procedures as outlined in Example 5.

### Example 10

### Hybridization Kinetics of a Polyacrylamide Having 10% Hydroxyl Group

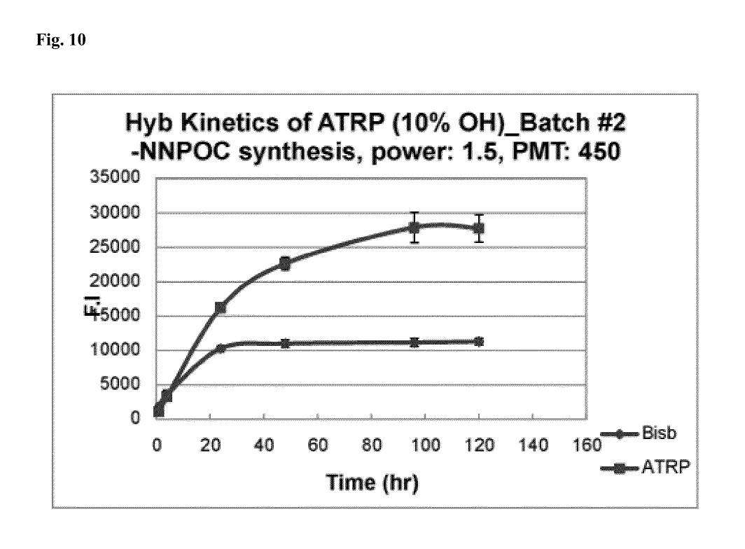

FIG. 10 show the hybridization kinetics of a polyacrylamide having 10% hydroxyl group. Hybridization kinetics was measured using the same experimental procedures as outlined in Example 8.

### Example 11

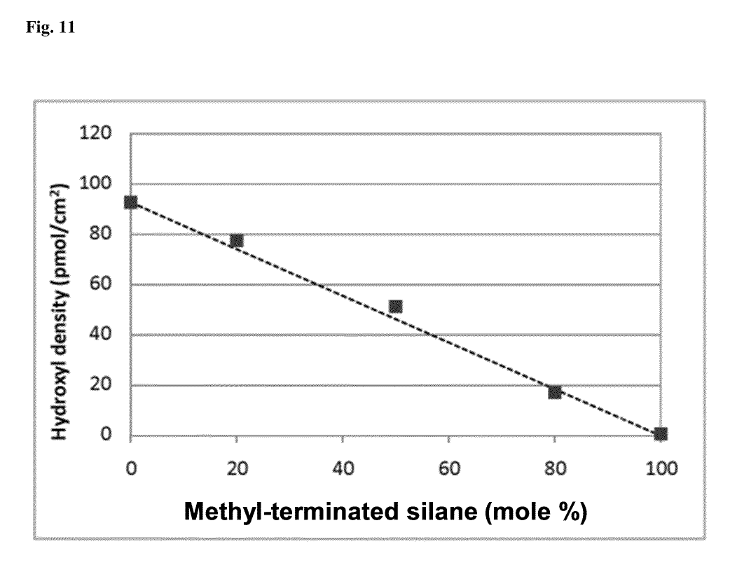

Surface hydroxyl site density on ATRP films was measured using the same experimental procedures as outlined in Example 5. FIG. 11 shows how the hydroxyl density of ATRP-2c polyacrylate co-polymer brush coatings can be controlled by varying the mole fraction of functional hydroxyethylacrylate in a two-component mixture with the non-functional monomer methoxyethylmethacrylate.

### Example 12

### Copolymer Exhibits Exceptional Hydrolytic Stability

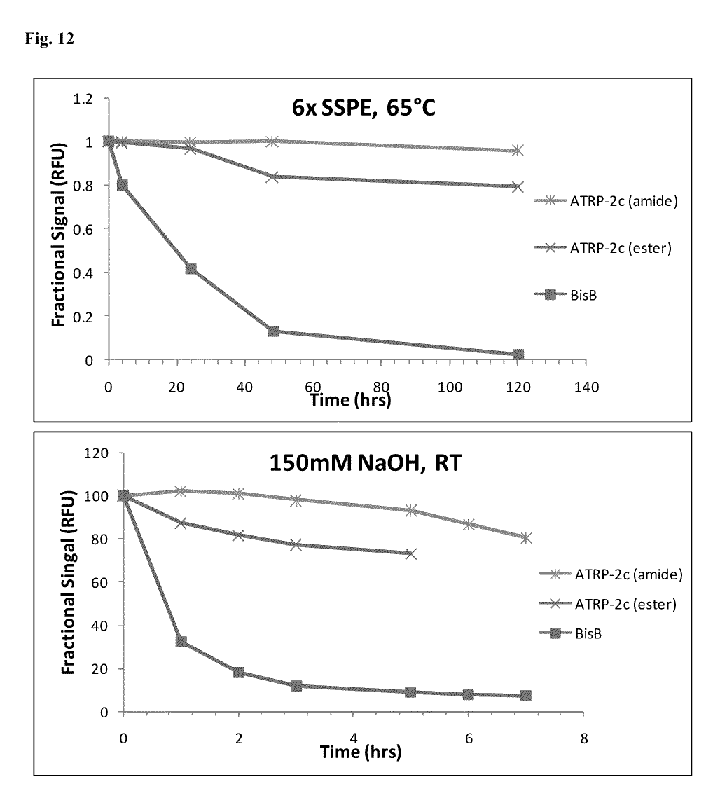

FIG. 12 shows that copolymer brush surface layers have exceptional hydrolytic stability. Hydrolytic stability was measured using the same experimental procedures as outlined in Example 7.

### Example 13

### “ATRP-1a”

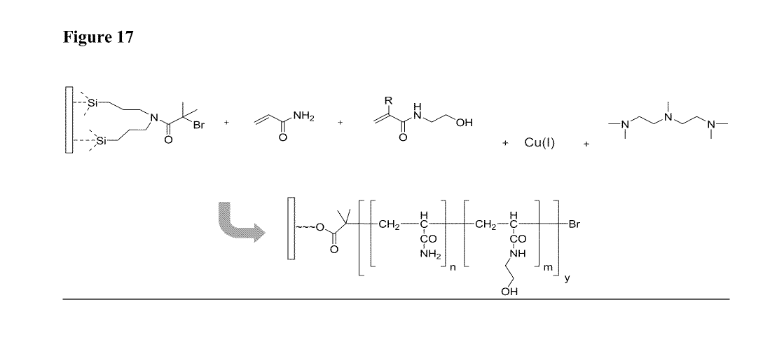

ATRP-1a is a polyacrylamide co-polymer brush coating was prepared from functional and nonfunctional acrylamide monomers as outlined below, using the protocols described for ATRP-2c and as shown in FIG. 17.

The resulting films exhibited the following characteristics: (1) uniform, highly wettable surface (contact angle ˜3°; (2) 180 Å dry film thickness; (3) a prominent IR absorption peak at 1675 cm⁻¹ (characteristic of amide carbonyl stretching mode); (4) ˜30 pmol/cm² hydroxyl density (2-dimensional basis); (5) uniform fluorescence stain image; (6) very high stability in aqueous buffers at elevated temperatures; (7) Compatible with oligonucleotide probe array synthesis processes; (8) ˜3-4× hybridization signal intensity over std. HEBS substrates; (9) exhibits very low background in array hybridization experiments; (10) fast hybridization kinetics (similar to HEBS substrates); (11) supports “on-chip” ligation and polymerase extension; and (12) excellent batch-to-batch consistency.

Although the invention is described in conjunction with the exemplary embodiments, the invention is not limited to these embodiments. On the contrary, the invention encompasses alternatives, modifications and equivalents, which may be included within the spirit and scope of the invention. The invention has many embodiments and relies on many patents, applications and other references for details. Therefore, when a patent, application, website or other reference is cited or repeated above, the entire disclosure of the document cited is incorporated by reference in its entirety for all purposes as well as for the proposition that is recited. All documents, e.g., publications and patent applications, cited in this disclosure, including the foregoing, are incorporated herein by reference in their entireties for all purposes to the same extent as if each of the individual documents were specifically and individually indicated to be so incorporated herein by reference in its entirety. Unless otherwise apparent from the context, any element, feature, embodiment, step, aspect or the like can be used in combination with any other.

1. A method of synthesizing a polymer array comprising
(a) contacting a surface of a substrate with at least one linker, wherein the linker has a backbone chain comprising at least 5 carbon atoms with a head group at one end and a functional tail group precursor at the other end, wherein molecules of the linker self-assemble in a monolayer on the surface of the substrate;
(b) converting the functional tail group precursor into a functional tail group;
(c) repeating steps (a) and (b) at least once, such that a further monolayer with a further linker having a backbone of at least five carbon atoms, a head group and a tail group assembles on top of previous monolayer via linking of the head group on the further linker molecules to the functional tail group of the linker molecules of the previous monolayer;
(d) synthesizing a polymer array monomer-by-monomer on the further monolayer wherein the first monomers of the polymers attach to the further monolayer via the functional tail group of the linker molecules of the further monolayer.

2. The method of claim 1, wherein the converting comprises deprotecting, activating or substituting the functional tail group precursor.

3. The method of claim 1, wherein the polymer array is a nucleic acid array.

4-12. (canceled)

13. The method of claim 1, wherein the backbone chain has 5-20 carbon atoms.

14. The method of claim 1, wherein the backbone chain has 8-18 carbon atoms.

15. The method of claim 1, wherein the backbone chain is a saturated alkane chain.

16. (canceled)

17. (canceled)

18. The method of claim 1, wherein the saturated alkane is a linear unbranched alkane.

19. The method of claim 1, wherein the head group is trichlorosilane, trimethoysilane, triethoxysilane, dialkylaminosilane or tris(dialkylamino) silane.

20-25. (canceled)

26. The method of claim 1, wherein the tail group is vinyl.

27. The method of claim 1, wherein the tail group is acetyloxy.

28. (canceled)

29. (canceled)

30. The method of claim 2, wherein the deprotecting or activating converts the functional group to a hydroxyl group by treating with sodium methoxide.

31. (canceled)

32. The method of claim 1, wherein the linker is contacted with the surface in a liquid solvent.

33. The method of claim 1, wherein the linker is contacted with the surface as a solventless vapor.

34. A method of derivatizing a surface of a substrate, comprising,
(a) contacting a surface of a substrate with at least one linker wherein the linker has a backbone chain comprising at least 5 carbon atoms with a head group at one end, and a functional tail group precursor at the other end, wherein molecules of the one or more linker self-assemble in a first monolayer on the surface of the substrate;
(b) converting the functional tail group precursor into a functional tail group;
(c) repeating step (a) such that a second monolayer of a second linker having a backbone of at least five carbon atoms, a head group and a tail group assembles on top of the first monolayer via linking of the head group on the second linker molecules of the second monolayer to the functional tail group of the linker molecules of the first monolayer.

35. The method of claim 33, wherein the converting comprises deprotecting, activating or substituting the functional tail group precursor.

36. The method of claim 33 further comprising
(d) converting the functional tail group precursor of the second linker into a functional tail group;
(e) synthesizing a polymer array on top of the second monolayer, wherein the first monomer of the polymers attaches via the functional tail group of the second linker.

37. The method of claim 33, wherein the nucleic acids are synthesized monomer-by-monomer.

38. The method of claim 33, further comprising repeating step (c)) n times such that n+1 monolayers are successively assembled on top of one another, and the polymer nucleic acid array is assembled on top of the n+1th monolayer linked to the tail group of the linker molecules of the nth monolayer.

39. A method of derivatizing a support, comprising
linking molecules of an initiation linker to a surface of a support, the initiation linker having a polymerization initiator distal to the surface;
extending the initiation linker by atom transfer radical polymerization using a mixture of a first monomer and a second monomer, wherein the first monomer has a functional group absent from the second monomer, the polymerization initiator initiates polymerization and monomers are incorporated into a polymer molecules extending from the initiation linker;
wherein the first monomer and the second monomer each is of the formula 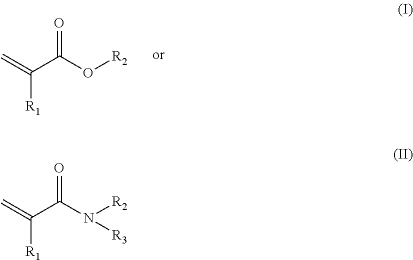
wherein R₁ is hydrogen or lower alkyl; R₂ and R₃ are independently hydrogen, or —Y—Z,
wherein Y is lower alkyl, and Z is hydroxyl, amino, or C(O)—R, where R is hydrogen, lower alkoxy or aryloxy.

40-70. (canceled)
